(19) United States
(12) Patent Application Publication
(10) Pub. No.: US 2011/0170793 A1
(43) Pub. Date: Jul. 14, 2011

(54) IMAGE PROCESSING APPARATUS AND METHOD

(76) Inventors: Kazushi Sato, Kanagawa (JP); Yoichi Yagasaki, Tokyo (JP)

(21) Appl. No.: 13/119,718

(22) PCT Filed: Sep. 24, 2009
(86) PCT No.: PCT/JP2009/066490

§ 371 Date: Mar. 17, 2011

(30) Foreign Application Priority Data
Sep. 24, 2008 (JP) 2008-243959

(51) Int. Cl. G06K 9/36

(52) U.S. Cl. 382/238

(57) ABSTRACT

The present invention relates to an image processing apparatus and method with which in an intra template matching system, it is possible to improve an encoding efficiency in a case where a change in luminance exists with respect to an identical texture in a screen.

An intra TP matching unit 75 performs matching based on the intra template matching system with respect to a block of an image in a frame of an encoding target to carry out a weighted prediction. A lossless encoding unit 66 inserts template system information representing whether Weighted Prediction is performed to a header part of a compressed image. The present invention can be applied to the image encoding apparatus that performs encoding, for example, in H.264/AVC system.

### TECHNICAL FIELD

The present invention relates to an image processing apparatus and method and particularly relates to an image processing apparatus and method with which in an intra template matching system, it is possible to improve an encoding efficiency in a case where a change in luminance exists with respect to an identical texture in a screen.

### BACKGROUND ART

In recent years, an apparatus that compresses and encodes an image is being spread by adopting a system such as MPEG (Moving Picture Experts Group phase) where image information is digitally dealt with, at that time, transmission and accumulation of the information at a high efficiency are aimed for, and by utilizing a redundancy unique to the image information, compression is carried out by orthogonal transform such as discrete cosine transform and motion compensation or the like.

In particular, MPEG2 (ISO/IEC 13818-2) is defined as a general-purpose image encoding system, which is a standard covering both of an interlaced scanning image and a sequential scanning image as well as a standard resolution image and a high definition image and is currently widely used in broad application for a professional use and a consumer use. By using the MPEG2 compression system, for example, a bit rate of 4 to 8 Mbps is assigned in the case of the interlaced scanning image of a standard resolution having 720×480 pixels, and a bit rate of 18 to 22 Mbps is assigned in the case of the interlaced scanning image of a high resolution having 1920×1088 pixels, so that it is possible to realize a high compression rate and a satisfactory image quality.

This MPEG2 is mainly targeted for high image quality encoding in conformity to a broadcasting use but does not correspond to a bit rate lower than MPEG1, that is, an encoding system with a still higher compression rate. However, with spread of mobile terminals, in the time to come, needs for such encoding system are expected to increase, and while corresponding to this, standardization of an MPEG4 encoding system is carried out. For example, with regard to an image encoding system of MPEG4, its specification is approved as an international standard in December 1998 as ISO/IEC 14496-2.

Furthermore, in recent years, with an aim of an image encoding for a TV meeting use, a standardization of a standard called H.26L (ITU-T Q6/16 VCEG) progresses. As compared with conventional encoding systems such as MPEG2 and MPEG4, it is known that H.26L requires more computation amounts for its encoding and decoding but realizes a still higher encoding efficiency. Also, currently, as part of activities on MPEG4, based on this H.26L, a function which is not supported by H.26L is also introduced, and standardization for realizing a still higher encoding efficiency is carried out as Joint Model of Enhanced-Compression Video Coding. This becomes an international standard under a name of H.264 and MPEG-4 Part10 (Advanced Video Coding, hereinafter which will be referred to as AVC) in March 2003.

Incidentally, as one of factors for the encoding systems of H.264 and AVC to realize the high encoding efficiency as compared with the conventional encoding system such as MPEG-2, a principle of the intra prediction can be enumerated, but in recent years, a method of improving an efficiency of the intra prediction is further proposed.

As such a method, for example, a method of searching for an area of an image where a correlation with a template area composed of a decoded image is the highest that is adjacent in a predetermined positional relation with respect to a block that is an encoding target on the target frame from a decoded image in a previously set search area on a frame of an encoding target (hereinafter, which will be referred to as target frame) and performing a motion prediction of the block on the basis of the searched area and a predetermined positional relation exists (for example, see NPL 1). This method is referred to as an intra template matching system.

### CITATION LIST

### Non Patent Literature

NPL 1: “Intra Prediction by Template Matching”, T. K. Tan et al, ICIP2006

### SUMMARY OF INVENTION

### Technical Problem

However, in the intra template matching system, in a case where a change in luminance exists due to gradation or the like in a screen with respect to an identical texture, the change appears as a prediction error, and the encoding efficiency decreases.

The present invention has been made in view of such circumstances and enables to improve, in an intra template matching system, an encoding efficiency in a case where a change in luminance with respect to an identical texture in a screen exists.

### Solution to Problem

An image processing apparatus according to an aspect of the present invention includes matching means that performs a matching processing based on an intra template matching system for a block of an image in a frame of an encoding processing or decoding target and prediction means that performs a weighted prediction by the matching means with respect to the matching processing.

The prediction means can perform the weighted prediction on the basis of flag information representing whether the weighted prediction is performed when the image is encoded.

The flag information indicates the weighted prediction is performed in a picture unit, a macro block unit, or a block unit, and the prediction means can refer to the flag information to perform the weighted prediction in the picture unit, the macro block unit, or the block unit.

The flag information indicates that the weighted prediction is performed in the macro block unit, and in a case where the flag information of the macro block is different from flag information of an adjacent macro block, the flag information is inserted to information including the image in the frame of the decoding target.

The flag information indicates that the weighted prediction is performed in the block unit, and in a case where the flag information of the block is different from flag information of an adjacent block, the flag information is inserted to information including the image in the frame of the decoding target.

The prediction means can perform the weighted prediction by using a weighting factor.

The prediction means can perform the weighted prediction by using the weighting factor inserted to information including the image in the frame of the decoding target.

Calculation means can be further included which calculates the weighting factor by using pixel values of templates in the intra template matching system and pixel values of matching areas that are areas in a search range where a correlation with the template is highest.

The calculation means can calculate the weighting factor by using an average value of the pixel values of the templates and an average value of the pixel values of the matching areas.

The calculation means can calculate the weighting factor through an expression while the average value of the pixel values of the templates is set as Ave(Cur_tmplt), the average value of the pixel values of the matching areas is set as Ave(Ref_tmplt), and the weighting factor is set as w₀:

w₀=Ave(Cur_tmplt)/Ave(Ref_tmplt).

The calculation means can approximate the weighting factor w₀ to a value represented in a format of X/(2ⁿ).

The prediction means can calculates the predicted pixel value through an expression using the weighting factor w₀ when a predicted pixel value of the block is set as Pred(Cur) and a pixel value of an area having an identical positional relation with a positional relation between the template and the block between the matching areas is set as Ref:

Pred(Cur)=w₀×Ref.

The prediction means can perform a clip processing in a manner that the predicted pixel value has a value in a range from 0 to an upper limit value that the pixel value of the image of the decoding target may take.

The prediction means can perform the weighted prediction by using an offset.

The prediction means can perform the weighted prediction by using the offset inserted to information including the image in the frame of the decoded target.

Calculation means can be further included which calculates the offset by using a pixel value of a template in the intra template matching system and a pixel value of a matching area that is an area in a search range where a correlation with the template is highest.

The calculation means can calculate the offset by using an average value of the pixel values of the templates and an average value of the pixel values of the matching areas.

The calculation means can calculate the offset through an expression when the average value of the pixel values of the templates is set as Ave(Cur_tmplt), the average value of the pixel values of the matching areas is set as Ave(Ref_tmplt), and the offset is set as d₀:

d₀=Ave(Cur_tmplt)−Ave(Ref_tmplt).

The prediction means can calculate the predicted pixel value through an expression using the offset d₀ when a predicted pixel value of the block is set as Pred(Cur) and a pixel value of an area having an identical positional relation with a positional relation between the template and the block between the matching areas is set as Ref:

Pred(Cur)=Ref+d₀.

The prediction means can perform a clip processing in a manner that the predicted pixel value has a value in a range from 0 to an upper limit value that the pixel value of the image of the decoding target may take.

An image processing method according to an aspect of the present invention includes the steps of causing an image processing apparatus to perform a matching processing based on an intra template matching system for a block of an image in a frame of an encoding target and performing a weighted prediction with respect to the matching processing.

According to the aspect of the present invention, the matching processing based on the intra template matching system is performed for the block of the image in the frame of the encoding target, and the weighted prediction is performed on the matching processing.

### Advantageous Effects of Invention

According to the present invention, in the intra template matching system, it is possible to improve, in the intra template matching system, the encoding efficiency in a case where a change in luminance with respect to the identical texture in the screen exists.

### BRIEF DESCRIPTION OF DRAWINGS

FIG. 1 is a block diagram illustrating a configuration of an embodiment of an image encoding apparatus to which the present invention is applied.

FIG. 2 is a diagram for describing a variable block size motion prediction/compensation processing.

FIG. 3 is a diagram for describing a ¼ pixel accuracy prediction/compensation processing.

FIG. 4 is a flow chart for describing an encoding processing by the image encoding apparatus of FIG. 1.

FIG. 5 is a flow chart for describing a prediction processing of FIG. 4.

FIG. 6 is a diagram for describing a processing order in the case of a 16×16 pixel intra prediction mode.

FIG. 7 illustrates types of a 4×4 pixel intra prediction mode of the luminance signal.

FIG. 8 illustrates types of the 4×4 pixel intra prediction mode of the luminance signal.

FIG. 9 is a diagram for describing a direction of a 4×4 pixel intra prediction.

FIG. 10 is a diagram for describing the 4×4 pixel intra prediction.

FIG. 11 is a diagram for describing an encoding in the 4×4 pixel intra prediction mode of the luminance signal.

FIG. 12 illustrates types of a 16×16 pixel intra prediction mode of the luminance signal.

FIG. 13 illustrates types of the 16×16 pixel intra prediction mode of the luminance signal.

FIG. 14 is a diagram for describing a 16×16 pixel intra prediction.

FIG. 15 illustrates types of an intra prediction mode of a color difference signal.

FIG. 16 is a flow chart for describing an intra prediction processing.

FIG. 17 is a diagram for describing an intra template matching system.

FIG. 18 is a flow chart for describing an intra template motion prediction processing.

FIG. 19 is a flow chart for describing an inter motion prediction processing.

FIG. 20 is a diagram for describing an example of a motion vector information generation method.

FIG. 21 is a block diagram illustrating a configuration of an embodiment of an image decoding apparatus to which the present invention is applied.

FIG. 22 is a flow chart for describing a decoding processing by the image decoding apparatus of FIG. 21.

FIG. 23 is a flow chart for describing a prediction processing of FIG. 22.

FIG. 24 illustrates an example of an expanded block size.

FIG. 25 is a block diagram illustrating a principal configuration example of a television receiver to which the present invention is applied.

FIG. 26 is a block diagram illustrating a principal configuration example of a mobile telephone device to which the present invention is applied.

FIG. 27 is a block diagram illustrating a principal configuration example of a hard disc recorder to which the present invention is applied.

FIG. 28 is a block diagram illustrating a principal configuration example of a camera to which the present invention is applied.

### DESCRIPTION OF EMBODIMENTS

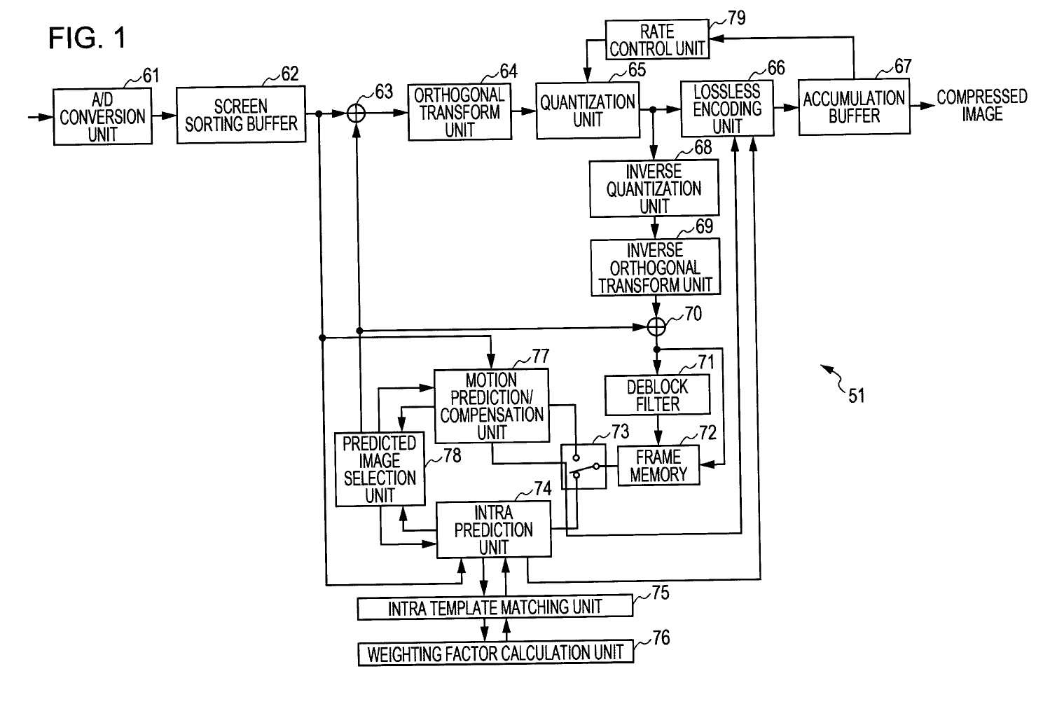

FIG. 1 illustrates a configuration of an embodiment of an image encoding apparatus of the present invention. This image encoding apparatus 51 is composed of an A/D conversion unit 61, a screen sorting buffer 62, a computation unit 63, an orthogonal transform unit 64, a quantization unit 65, a lossless encoding unit 66, an accumulation buffer 67, an inverse quantization unit 68, an inverse orthogonal transform unit 69, a computation unit 70, a deblock filter 71, a frame memory 72, a switch 73, an intra prediction unit 74, an intra template matching unit 75, a weighting factor calculation unit 76, a motion prediction/compensation unit 77, a predicted image selection unit 78, and a rate control unit 79.

It should be noted that hereinafter, the intra template matching unit 75 will be referred to as intra TP matching unit 75.

This image encoding apparatus 51 compresses and encodes an image, for example, in H.264 and AVC (hereinafter, which will be referred to as H.264/AVC) system.

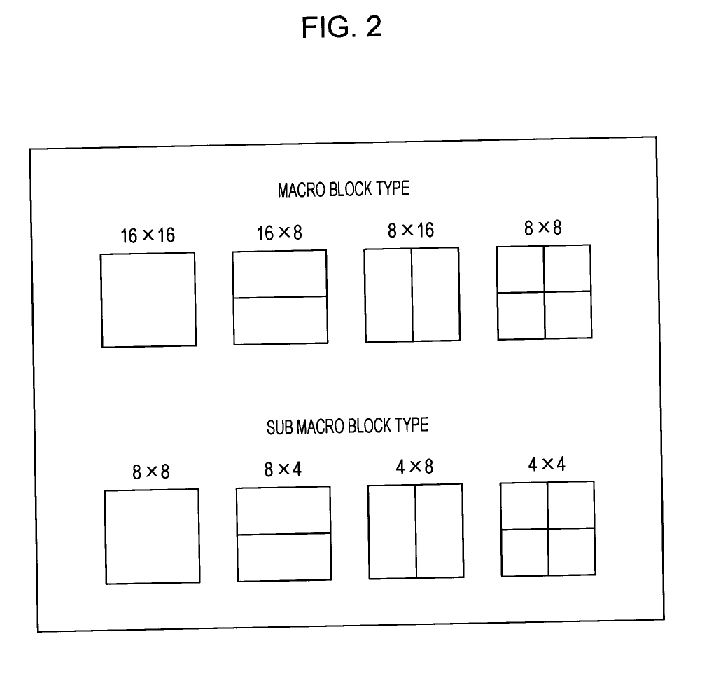

In the H.264/AVC system, while a block size is variable, a motion prediction/compensation is carried out. That is, in the H.264/AVC system, one macro block composed of 16×16 pixels is divided, as illustrated in FIG. 2, into either partition of 16×16 pixels, 16×8 pixels, 8×16 pixels, or 8×8 pixels, and it is possible to hold mutually independent motion vector information. Also, with regard to the 8×8 pixel partition, as illustrated in FIG. 2, a division into either sub partition of 8×8 pixels, 8×4 pixels, 4×8 pixels, or 4×4 pixels, and it is possible to hold mutually independent motion vector information.

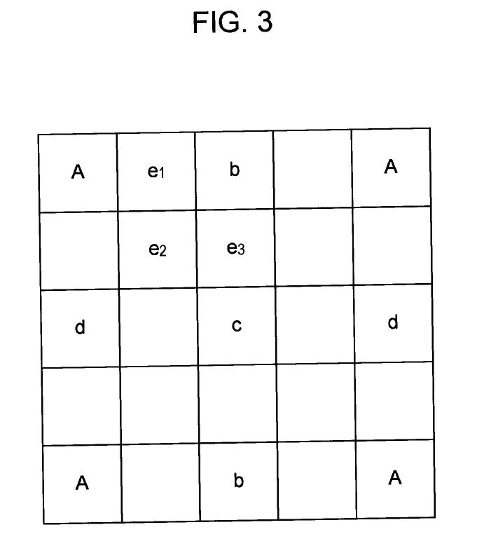

Also, in the H.264/AVC system, a ¼ pixel accuracy prediction/compensation processing using a 6-tap FIR filter is carried out. With reference to FIG. 3, a decimal pixel accuracy prediction/compensation processing in the H.264/AVC system will be described.

In an example of FIG. 3, a position A indicates an integer accuracy pixel position, positions b, c, and d indicate ½ pixel accuracy positions, and positions e1, e2, and e3 indicate ¼ pixel accuracy positions. First, in the following, Clip( ) is defined as the following expression (1).

$$\begin{matrix}[ Formula 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

It should be noted that in a case where the input image is 8-bit accuracy, a value of max_pix becomes 255.

At this time, pixel values in the positions b and d are obtained by the 6-tap FIR filter by the following expression (2).

[Formula 2]

F=A₋₂−5·A₋₁+20·A₀+20·A₁−5·A₂+A₃

b, d=Clip1((F+16)>>5) (2)

It should be noted that in the expression (2), Aₚ (p=−2, −1, 0, 1, 2, 3) is a pixel value in the position A where a distance in a horizontal direction or a vertical direction from the position A corresponding to the position b or d is p. Also, in the expression (2), b and d are respectively a pixel value in the position b and a pixel value in the position d.

Also, a pixel value in the position c is obtained by applying the 6-tap FIR filter in the horizontal direction and the vertical direction by the following expression (3).

[Formula 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10) (3)

It should be noted that in the expression (3), bₚ, dₚ (p=−2, −1, 0, 1, 2, 3) is a pixel value in the position b, d where a distance from the position b, d corresponding to the position c in the horizontal direction or the vertical direction is p, and c is a pixel value in the position c. Also, in the expression (3), a Clip processing is executed only once at the last after a computation of F in the expression (3), that is, a product-sum operation in both the horizontal direction and the vertical direction is carried out.

Furthermore, the pixel values in the positions e₁ to e₃ are obtained by a linear interpolation as in the following expression (4).

[Formula 4]

e₁=(A+b+1)>>1

e₂=(b+d+1)>>1

e₃=(b+c+1)>>1 (4)

It should be noted that in the expression (4), A, a to d, and e₁ to e₃ are respectively pixel values in the positions A, a to d, and e₁ to e₃.

While referring back to FIG. 1, the A/D conversion unit 61 performs an A/D conversion on an input image to be output to the screen sorting buffer 62 and stored. The screen sorting buffer 62 sorts images of frames in a stored display order in accordance with GOP (Group of Picture) into an order of frames for encoding.

The computation unit 63 subtracts a predicted image from the intra prediction unit 74 or a predicted image from the motion prediction/compensation unit 77 which is selected by the predicted image selection unit 78, from the image read from the screen sorting buffer 62 and outputs difference information thereof to the orthogonal transform unit 64. The orthogonal transform unit 64 applies an orthogonal transform such as discrete cosine transform or Karhunen-Loeve transform on the difference information from the computation unit 63 and outputs a transform coefficient thereof. The quantization unit 65 quantizes the transform coefficient output from the orthogonal transform unit 64.

The quantized transform coefficient that is an output of the quantization unit 65 is input to the lossless encoding unit 66. Herein, the quantized transform coefficient is applied with lossless encoding such as variable length coding like CAVLC (Context-based Adaptive Variable Length Coding) or arithmetic coding like CABAC (Context-based Adaptive Binary Arithmetic Coding) and compressed. It should be noted that the compressed image is accumulated in the accumulation buffer 67 and then output.

Also, the quantized transform coefficient output from the quantization unit 65 is also input to the inverse quantization unit 68, inversely quantized, and then further subjected to inverse orthogonal transform in the inverse orthogonal transform unit 69. An output after the inverse orthogonal transform is added with the predicted image supplied from the predicted image selection unit 78 by the computation unit 70 and becomes an image locally decoded.

The deblock filter 71 removes a block distortion of the decoded image to be then supplied to the frame memory 72 and accumulated. The frame memory 72, an image before the deblock filter processing by the deblock filter 71 is also supplied and accumulated.

The switch 73 outputs the image accumulated in the frame memory 72 to the motion prediction/compensation unit 77 or the intra prediction unit 74.

In this image encoding apparatus 51, for example, an I picture, a B picture, and a P picture from the screen sorting buffer 62 are supplied as images where an intra prediction (which is also referred to as intra processing) is carried out to the intra prediction unit 74. Also, the B picture and the P picture read out from the screen sorting buffer 62 are supplied as images where an inter prediction (which is also referred to as inter processing) is carried out to the motion prediction/compensation unit 77.

The intra prediction unit 74 performs an intra prediction processing in all candidate intra prediction modes to generate a predicted image on the basis of the images where the intra prediction is carried out which are read out from the screen sorting buffer 62 and an image functioning as a reference image supplied from the frame memory 72 via the switch 73.

Also, the intra prediction unit 74 supplies the image supplied from the frame memory 72 via the switch 73 to the intra TP matching unit 75.

The intra prediction unit 74 calculates cost function values with respect to all the candidate intra prediction modes. Among the calculated cost function values and a cost function value with respect to an intra template prediction mode calculated by the intra TP matching unit 75, the intra prediction unit 74 decides a prediction mode where the smallest value is given as an optimal intra prediction mode.

The intra prediction unit 74 supplies the predicted image generated by an optimal intra prediction mode and the cost function value thereof to the predicted image selection unit 78. In a case where the predicted image generated in the optimal intra prediction mode is selected by the predicted image selection unit 78, the intra prediction unit 74 supplies information related to the optimal intra prediction mode (prediction mode information, template system information, or the like) to the lossless encoding unit 66. The lossless encoding unit 66 applies lossless encoding on this information to be set as a part of header information in the compressed image.

On the basis of the image supplied from the intra prediction unit 74, in an intra template matching system or an intra template Weighted Prediction system (detail will be described below), the intra TP matching unit 75 performs the motion prediction and compensation processing in the intra template prediction mode. As a result, a predicted image is generated.

It should be noted that the intra template Weighted Prediction system is a system in which the intra template matching system is combined with Weighted Prediction. A weighting factor or an offset value used in the Weighted Prediction system is supplied from the weighting factor calculation unit 76.

Also, the intra TP matching unit 75 supplies the image supplied from the intra prediction unit 74 to the weighting factor calculation unit 76. Furthermore, the intra TP matching unit 75 calculates a cost function value with respect to the intra TP prediction mode and supplies the calculated cost function value, the predicted image, and template system information (flag information) to the intra prediction unit 74.

It should be noted that the template system information is information representing whether the intra template Weighted Prediction system is adopted or the intra template matching system is adopted as the system for the motion prediction/compensation processing by the intra TP matching unit 75. That is, the template system information functions as a flag representing whether the Weighted Prediction is carried out.

On the basis of the image supplied from the intra TP matching unit 75, the weighting factor calculation unit 76 calculates the weighting factor or the offset value in an intra template matching block unit to be supplied to the intra TP matching unit 75. It should be noted that a detail of the processing by the weighting factor calculation unit 76 will be described below.

The motion prediction/compensation unit 77 performs the motion prediction/compensation processing in all candidate inter prediction modes. That is, on the basis of the image read out from the screen sorting buffer 62 and subjected to the inter prediction and an image functioning as a reference image supplied via the switch 73 from the frame memory 72, the motion prediction/compensation unit 77 detects motion vectors in all the candidate inter prediction modes and applies a motion prediction and compensation processing on the reference image on the basis of the motion vectors to generate a predicted image.

Also, the motion prediction/compensation unit 77 calculates cost function values with respect to all the candidate inter prediction modes. Among the calculated cost function values with respect to the inter prediction modes, the motion prediction/compensation unit 77 decides a prediction mode where the smallest value is given as an optimal inter prediction mode.

The motion prediction/compensation unit 77 supplies the predicted image generated in the optimal inter prediction mode and the cost function value thereof to the predicted image selection unit 78. In a case where the predicted image generated in the optimal inter prediction mode is selected by the predicted image selection unit 78, the motion prediction/compensation unit 77 outputs information related to the optimal inter prediction mode and information related to the optimal inter prediction mode thereof (such as motion vector information or reference frame information) to the lossless encoding unit 66. The lossless encoding unit 66 performs a lossless encoding processing such as variable length coding or arithmetic coding on the information from the motion prediction/compensation unit 77 to be inserted to a header part of the compressed image.

On the basis of the respective cost function values output from the intra prediction unit 74 or the motion prediction/compensation unit 77, the predicted image selection unit 78 decides an optimal prediction mode from the optimal intra prediction mode and the optimal inter prediction mode and selects the predicted image in the decided optimal prediction mode to be supplied to the computation units 63 and 70. At this time, the predicted image selection unit 78 supplies the selection information on the predicted image to the intra prediction unit 74 or the motion prediction/compensation unit 77.

On the basis of the compressed images accumulated in the accumulation buffer 67, so as not to generate overflow or underflow, the rate control unit 79 controls a rate of a quantization operation of the quantization unit 65.

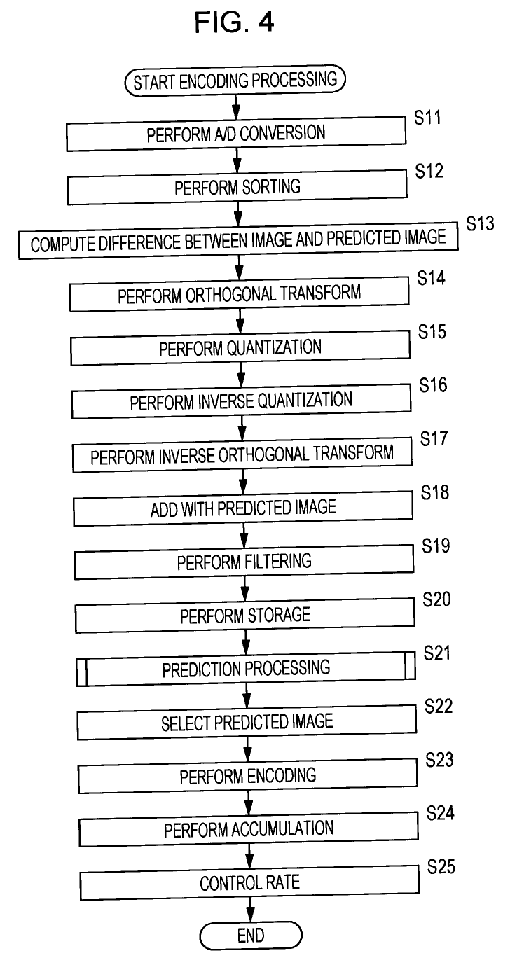

Next, with reference to a flow chart of FIG. 4, an encoding processing by the image encoding apparatus 51 of FIG. 1 will be described.

In step S11, the A/D conversion unit 61 performs A/D conversion on the input image. In step S12, the screen sorting buffer 62 stores an image supplied from the A/D conversion unit 61 and performs sorting from an order of displaying the respective pictures to an order for encoding.

In step S13, the computation unit 63 computes a difference between the image sorted in step S12 and a predicted image. The predicted image is supplied from the motion prediction/compensation unit 77 in a case where the inter prediction is performed and from the intra prediction unit 74 in a case where the intra prediction is performed respectively via the predicted image selection unit 78 to the computation unit 63.

Difference data has a smaller data amount as compared with the original image data. Therefore, as compared with a case where the image is encoded as it is, it is possible to compress the data amount.

In step S14, the orthogonal transform unit 64 performs orthogonal transform on difference information supplied from the computation unit 63. To be more specific, orthogonal transform such as discrete cosine transform or Karhunen-Loeve transform is performed, and a transform coefficient is output. In step S15, the quantization unit 65 quantizes the transform coefficient. At the time of this quantization, as will be described in a processing in step S25 which will be described below, a rate is controlled.

The difference information quantized in the above-mentioned manner is locally decoded in the following manner. That is, in step S16, the inverse quantization unit 68 inversely quantizes the transform coefficient quantized by the quantization unit 65 in accordance with a characteristic corresponding to a characteristic of the quantization unit 65. In step S17, the inverse orthogonal transform unit 69 performs inverse orthogonal transform on the transform coefficient inversely quantized by the inverse quantization unit 68 in a characteristic corresponding to a characteristic of the orthogonal transform unit 64.

In step S18, the computation unit 70 adds the predicted image input via the predicted image selection unit 78 to the locally decoded difference information and generates a locally decoded image (image corresponding to the input to the computation unit 63). In step S19, the deblock filter 71 filters the image output from the computation unit 70. According to this, the block distortion is removed. In step S20, the frame memory 72 stores the image subjected to the filtering. It should be noted that the frame memory 72 is also supplied with an image that is not subjected to the filter processing by the deblock filter 71 from the computation unit 70 to be stored.

In step S21, the intra prediction unit 74, the intra TP matching unit 75, and the motion prediction/compensation unit 77 respectively perform a prediction processing on the image. That is, in step S21, the intra prediction unit 74 performs the intra prediction processing in the intra prediction mode, the intra TP matching unit 75 performs the motion prediction/compensation processing in the intra template prediction mode, and the motion prediction/compensation unit 77 performs the motion prediction/compensation processing in the inter prediction mode.

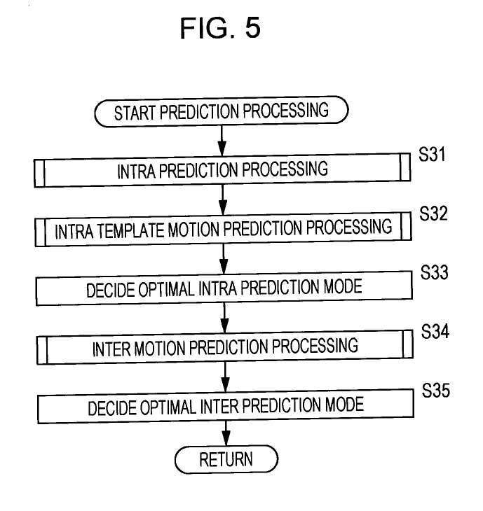

A detail of the prediction processing in step S21 will be described below with reference to FIG. 5, and with this processing, the prediction processings are performed respectively in all the candidate prediction modes, and cost function values are calculated respectively in all the candidate prediction modes. Then, on the basis of the calculated cost function values, among the intra prediction mode and the intra template prediction mode, the optimal intra prediction mode is decided, and the predicted image generated in the optimal intra prediction mode and the calculated cost function value thereof are supplied to the predicted image selection unit 78. Also, on the basis of the calculated cost function values, the optimal inter prediction mode is selected, and the predicted image generated in the optimal inter prediction mode and the calculated cost function value thereof are supplied to the predicted image selection unit 78.

In step S22, on the basis of the respective cost function values output by the intra prediction unit 74 and the motion prediction/compensation unit 77, the predicted image selection unit 78 decides one of the optimal intra prediction mode and the optimal inter prediction mode as the optimal prediction mode and selects the predicted image in the decided optimal prediction mode to be supplied to the computation units 63 and 70. This predicted image is utilized for the computation in steps S13 and S18 as described above.

It should be noted that this selection information on the predicted image is supplied to the intra prediction unit 74 or the motion prediction/compensation unit 77. In a case where the predicted image in the optimal intra prediction mode is selected, the intra prediction unit 74 supplies the information on the optimal intra prediction mode (prediction mode information, template system information, or the like) to the lossless encoding unit 66.

That is, as the optimal intra prediction mode, when the predicted image in the intra prediction mode is selected, the intra prediction unit 74 outputs information representing the intra prediction mode (hereinafter, which will be appropriately referred to as intra prediction mode information) to the lossless encoding unit 66.

On the other hand, as the optimal intra prediction mode, when the predicted image in the intra template prediction mode is selected, the intra prediction unit 74 outputs information representing the intra template prediction mode (hereinafter, which will be appropriately referred to as intra template prediction mode information) and the template system information to the lossless encoding unit 66.

Also, in a case where the predicted image in the optimal inter prediction mode is selected, the motion prediction/compensation unit 77 outputs information related to the optimal inter prediction mode and information related to the optimal inter prediction mode thereof (the motion vector information, the reference frame information, and the like) to the lossless encoding unit 66.

In step S23, the lossless encoding unit 66 encodes the quantized transform coefficient output by the quantization unit 65. That is, the difference image is subjected to lossless encoding such as variable length coding or arithmetic coding and compressed. At this time, the information from the intra prediction unit 74 related to the optimal intra prediction mode which is input to the lossless encoding unit 66 in the above-mentioned S22, the information from the motion prediction/compensation unit 77 related to the optimal intra prediction mode, the information in accordance with the optimal inter prediction mode (reference frame information, motion vector information, and the like) and the like are also encoded and inserted to the header information.

In step S24, the accumulation buffer 67 accumulates the compressed difference image as the compressed image. The compressed image accumulated in the accumulation buffer 67 is appropriately read out and transmitted to a decoding side via a transmission path.

In step S25, on the basis of the compressed images accumulated in the accumulation buffer 67, so as not to generate overflow or underflow, the rate control unit 79 controls a rate of a quantization operation of the quantization unit 65.

Next, with reference to a flow chart of FIG. 5, the prediction processing in step S21 of FIG. 4 will be described.

In a case where the processing target image supplied from the screen sorting buffer 62 is an image in the block subjected to the intra processing, the decoded image to be referred to is read out from the frame memory 72 and supplied via the switch 73 to the intra prediction unit 74. On the basis of these images, in step S31, the intra prediction unit 74 performs the intra prediction on the processing target block pixels in all the candidate intra prediction modes. It should be noted that as the decoded pixels to be referred to, the pixels that are not subjected to the deblock filtering by the deblock filter 71 are used.

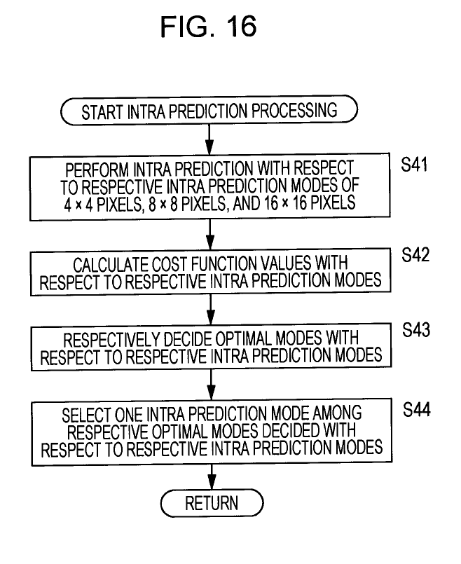

A detail of the intra prediction processing in step S31 will be described below with reference to FIG. 16, and with this processing, the intra prediction in all the candidate intra prediction modes is performed, and the cost function values are calculated with respect to all the candidate intra prediction modes.

Furthermore, in a case where the processing target image supplied from the screen sorting buffer 62 is an image subjected to the intra processing, the decoded image to be referred to that is read out from the frame memory 72 is also supplied via the switch 73 and the intra prediction unit 74 to the intra TP matching unit 75. On the basis of these images, the intra TP matching unit 75 and the weighting factor calculation unit 76 performs an intra template motion prediction processing in the intra template prediction mode in step S32.

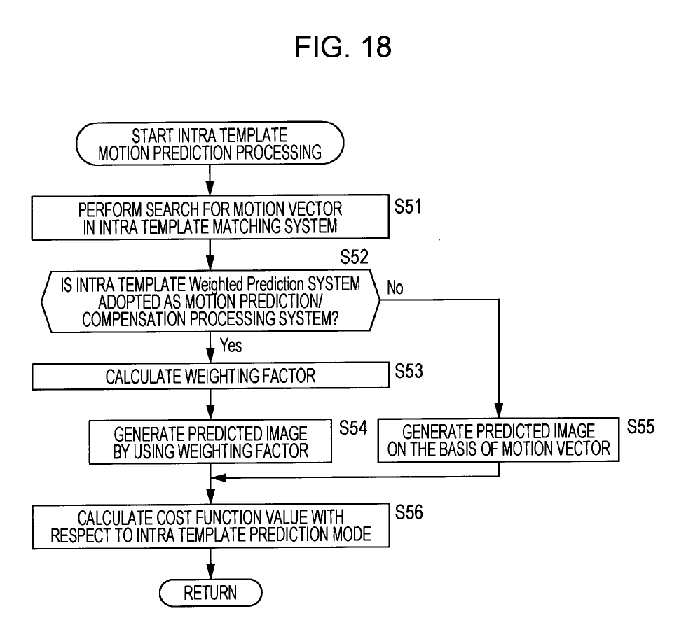

A detail of the intra template motion prediction processing in step S32 will be described below with reference to FIG. 18, and with this processing, the motion prediction processing in the intra template prediction mode is performed, and the cost function values are calculated with respect to the intra template prediction mode. Then, the predicted image generated through the motion prediction processing in the intra template prediction mode and the cost function value thereof are supplied to the intra prediction unit 74.

In step S33, the intra prediction unit 74 compares the cost function value with respect to the optimal intra prediction mode which is selected in step S31 with the cost function value with respect to the intra template prediction mode calculated in step 32 and decides the prediction mode where the smallest value is given as the optimal intra prediction mode. Then, the intra prediction unit 74 supplies the predicted image generated in the optimal intra prediction mode and the calculated cost function value thereof to the predicted image selection unit 78.

In a case where the processing target image supplied from the screen sorting buffer 62 is an image subjected to the inter processing, the decoded image to be referred to is read out from the frame memory 72 and supplied via the switch 73 to the motion prediction/compensation unit 77. On the basis of these images, in step S34, the motion prediction/compensation unit 77 performs an inter motion prediction processing. That is, the motion prediction/compensation unit 77 refers to the decoded image supplied from the frame memory 72 and performs the motion prediction processing in all the candidate inter prediction modes.

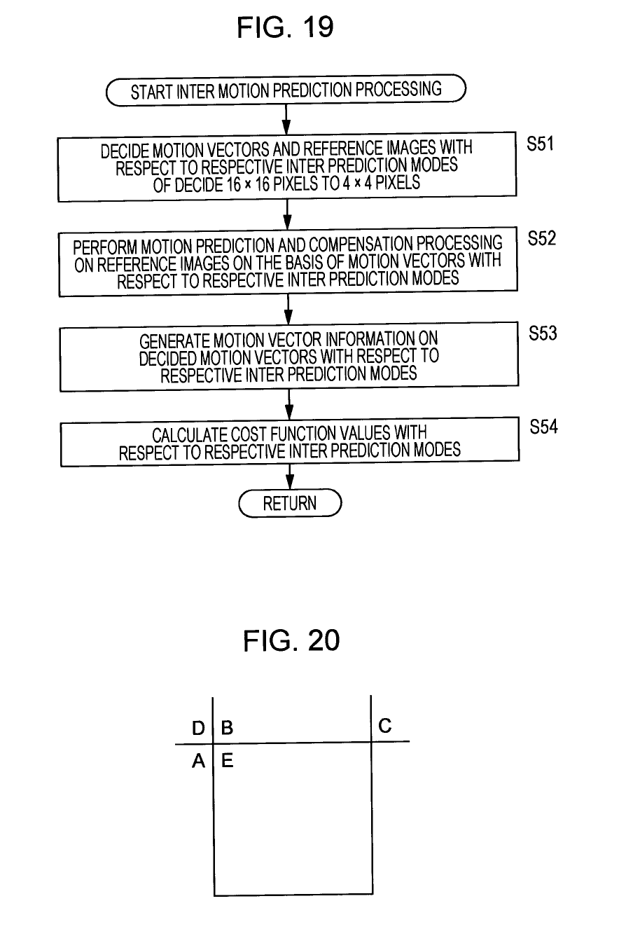

A detail of the inter motion prediction processing in step S34 will be described below with reference to FIG. 19, with this processing, the motion prediction processing in all the candidate inter prediction modes is performed, and the cost function values are calculated with respect to all the candidate inter prediction modes.

In step S35, the motion prediction/compensation unit 77 compares the cost function values with respect to all the candidate intra template prediction modes calculated in step S34 and decides the prediction mode where the smallest value is given as the optimal inter prediction mode. Then, the motion prediction/compensation unit 77 supplies the predicted image generated in the optimal inter prediction mode and the calculated cost function value thereof to the predicted image selection unit 78.

Next, respective modes of the intra prediction set by the H.264/AVC system will be described.

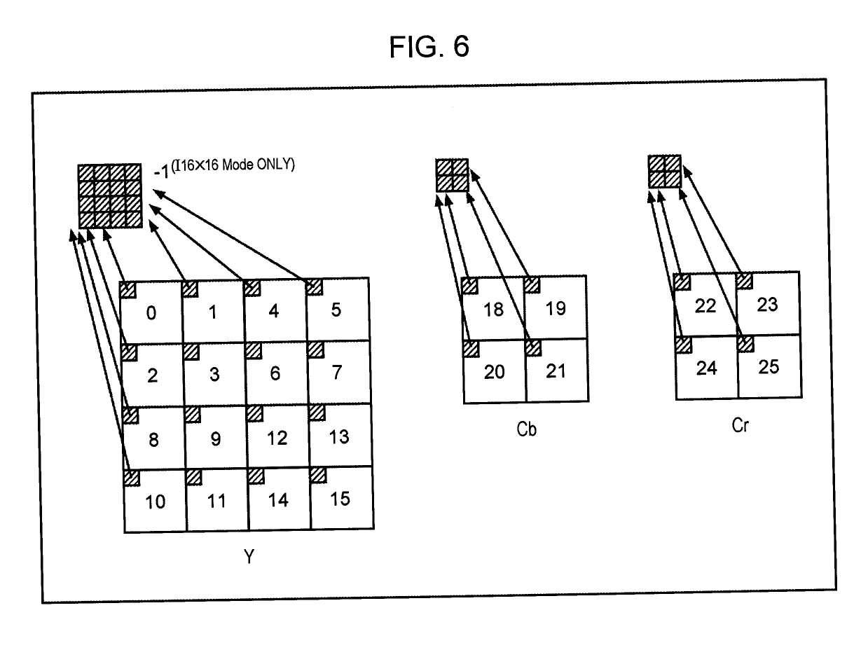

First, an intra prediction mode with respect to a luminance signal will be described. The intra prediction modes of the luminance signal include prediction modes of nine types of 4×4 pixel block units and four types of 16×16 pixel macro block units. As illustrated in FIG. 6, in the case of the 16×16 pixel intra prediction mode, by gathering direct current components of the respective blocks, a 4×4 matrix is generated, and with respect to this, furthermore, an orthogonal transform is performed.

It should be noted that with regard to a high profile, with respect to an 8th-order DCT block, an 8×8 pixel block unit prediction mode is set, but this system is pursuant to a system of a 4×4 pixel intra prediction mode that will be described next.

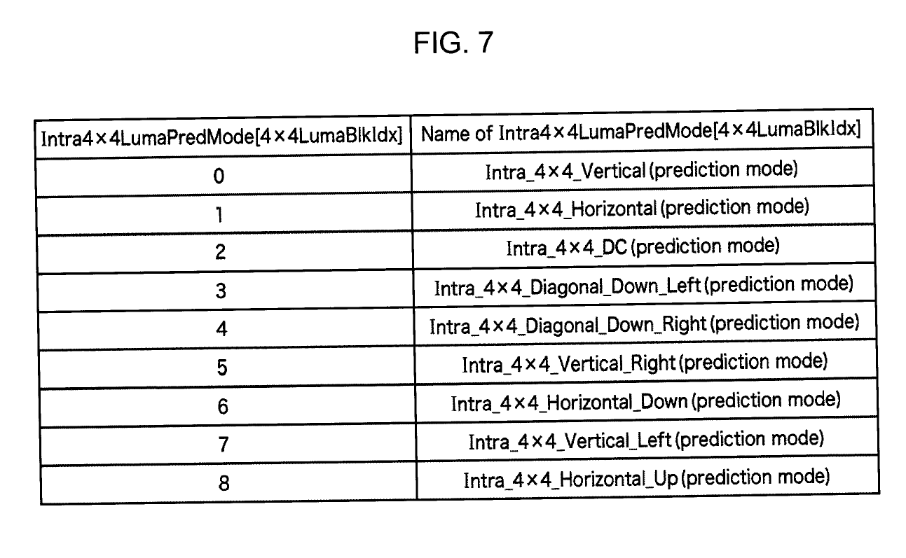

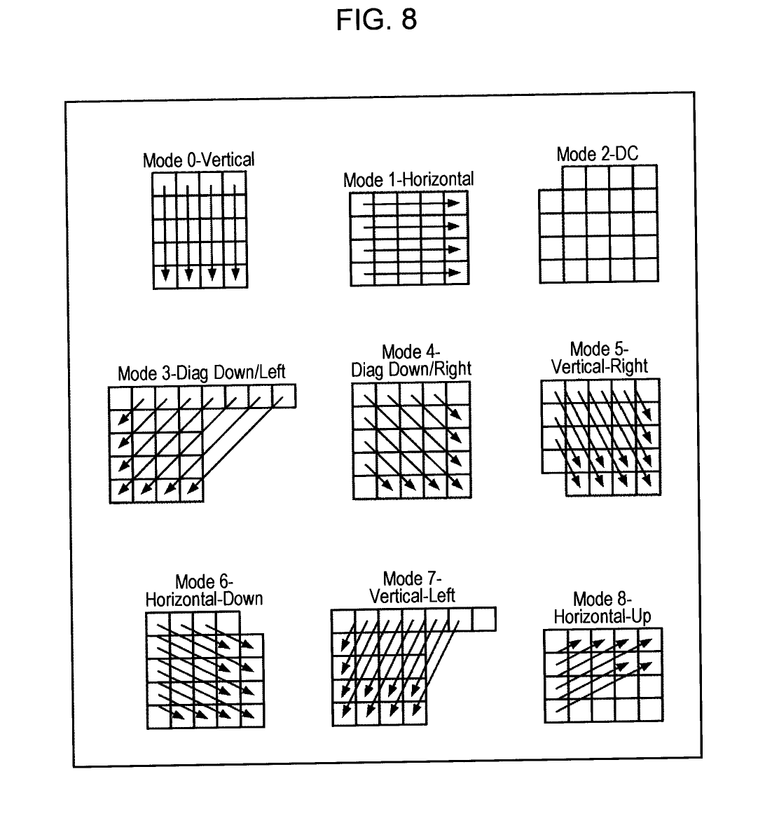

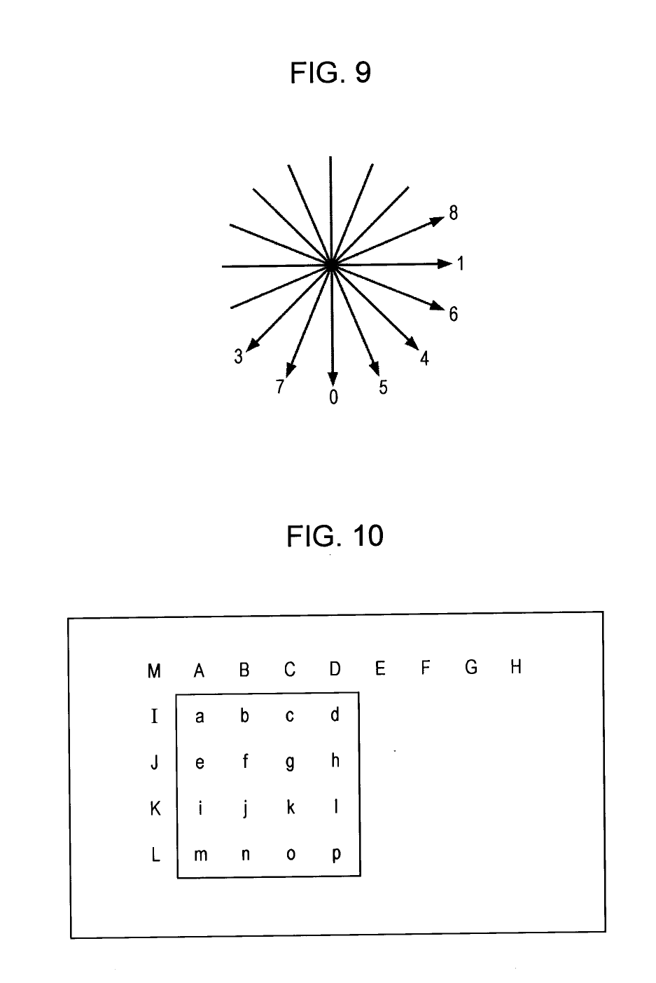

FIG. 7 and FIG. 8 illustrate nine types of 4×4 pixel intra prediction mode (Intra_{—}4×4_pred_mode) of the luminance signal. Eight types of the respective modes except for mode 2 indicating an average value (DC) prediction respectively correspond to directions indicated by numbers 0, 1, and 3 to 8 of FIG. 9.

The nine types of Intra_{—}4×4_pred_mode will be described with reference to FIG. 10. In an example of FIG. 10, pixels a to p represent pixels in target blocks to be subjected to the intra processing, and pixel values A to M represent pixel values of pixels belonging to adjacent blocks. That is, the pixels a to p are images of the processing targets which are read out from the screen sorting buffer 62, and the pixel values A to M are pixel values of decoded images before the deblock filter processing which are read as the reference images from the frame memory 72.

In the case of the respective intra prediction modes of FIG. 7 and FIG. 8, the predicted pixel values of the pixels a to p are generated in the following manner by using the pixel values A to M of the pixels belonging to the adjacent blocks. It should be noted that a state in which the pixel value is “available” represents that utilization is possible without a reason of being at an edge of an image frame, not encoded yet, or the like, and a state in which the pixel value is “unavailable” represents that utilization is not possible due to a reason of being at the edge of the image frame, not encoded yet, or the like.

The mode 0 is Vertical Prediction and applied only in a case where the pixel values A to D are “available”. In this case, the predicted pixel values of the pixels a to p are calculated by the following expression (5).

The predicted pixel value of the pixels a, e, i, and m=A

The predicted pixel value of the pixels b, f, j, and n=B

The predicted pixel value of the pixels c, g, k, and o=C

The predicted pixel value of the pixels d, h, l, and p=D (5)

The mode 1 is Horizontal Prediction and is applied only in a case where the pixel values I to L are “available”. In this case, the predicted pixel values of the pixels a to p are calculated by the following expression (6).

The predicted pixel value of the pixels a, b, c, and d=I

The predicted pixel value of the pixels e, f, g, and h=J

The predicted pixel value of the pixels i, j, k, and l=K

The predicted pixel value of the pixels m, n, o, and p=L (6)

The mode 2 is DC Prediction and when the pixel values A, B, C, D, I, J, K, and L are all “available”, the predicted pixel values are calculated by an expression (7).

(A+B+C+D+i+J+K+L+4)>>3 (7)

Also, when the pixel values A, B, C, and D are all “unavailable”, the predicted pixel values are calculated by an expression (8).

(I+J+K+L+2)>>2 (8)

Also, when the pixel values I, J, K, and L are all “unavailable”, the predicted pixel values are calculated by an expression (9).

(A+B+C+D+2)>>2 (9)

It should be noted that when the pixel values A, B, C, D, I, J, K, and L are all “unavailable”, 128 is used as the predicted pixel value.

The mode 3 is Diagonal_Down_Left Prediction is applied only in a case where the pixel values A, B, C, D, I, J, K, L, and M are “available”. In this case, the predicted pixel values of the pixels a to p are generated as in the following expression (10).

The predicted pixel value of the pixel a=(A+2B+C+2)>>2

The predicted pixel value of the pixels b and e=(B+2C+D+2)>>2

The predicted pixel value of the pixels c, f, and i=(C+2D+E+2)>>2

The predicted pixel value of the pixels d, g, j, and m=(D+2E+F+2)>>2

The predicted pixel value of the pixels h, k, and n=(E+2F+G+2)>>2

The predicted pixel value of the pixels l and o=(F+2G+H+2)>>2

The predicted pixel value of the pixel p=(G+3H+2)>>2 (10)

The mode 4 is Diagonal_Down_Right Prediction is applied only in a case where the pixel values A, B, C, D, I, J, K, L, and M are “available”. In this case, the predicted pixel values of the pixels a to p are generated as in the following expression (11).

The predicted pixel value of the pixel m=(J+2K+L+2)>>2

The predicted pixel value of the pixels i and n=(I+2J+K+2)>>2

The predicted pixel value of the pixels e, j, and o=(M+21+J+2)>>2

The predicted pixel value of the pixels a, f, k, and p=(A+2M+I+2)>>2

The predicted pixel value of the pixels b, g, and l=(M+2A+B+2)>>2

The predicted pixel value of the pixels c and h=(A+2B+C+2)>>2

The predicted pixel value of the pixel d=(B+2C+D+2)>>2 (11)

The mode 5 is Diagonal_Vertical_Right Prediction is applied only in a case where the pixel values A, B, C, D, I, J, K, L, and M are “available”. In this case, the predicted pixel values of the pixels a to p are generated as in the following expression (12).

The predicted pixel value of the pixels a and j=(M+A+1)>>1

The predicted pixel value of the pixels b and k =(A+B+1)>>1

The predicted pixel value of the pixels c and l=(B+C+1)>>1

The predicted pixel value of the pixel d=(C+D+1)>>1

The predicted pixel value of the pixels e and n=(I+2M+A+2)>>2

The predicted pixel value of the pixels f and o=(M+2A+B+2)>>2

The predicted pixel value of the pixels g and p=(A+2B+C+2)>>2

The predicted pixel value of the pixel h=(B+2C+D+2)>>2

The predicted pixel value of the pixel i=(M+2I+J+2)>>2

The predicted pixel value of the pixel m=(I+2J+K+2)>>2 (12)

The mode 6 is Horizontal_Down Prediction is applied only in a case where the pixel values A, B, C, D, I, J, K, L, and M are “available”. In this case, the predicted pixel values of the pixels a to p are generated as in the following expression (13).

The predicted pixel value of the pixels a and g=(M+I+1)>>1

The predicted pixel value of the pixels b and h=(I+2M+A+2)>>2

The predicted pixel value of the pixel c=(M+2A+B+2)>>2

The predicted pixel value of the pixel d=(A+2B+C+2)>>2

The predicted pixel value of the pixels e and k=(I+J+1)>>1

The predicted pixel value of the pixels f and l=(M+2I+J+2)>>2

The predicted pixel value of the pixels i and o=(J+K+1)>>1

The predicted pixel value of the pixels j and p=(I+2J+K+2)>>2

The predicted pixel value of the pixel m=(K+L+1)>>1

The predicted pixel value of the pixel n=(J+2K+L+2)>>2 (13)

The mode 7 is Vertical_Left Prediction is applied only in a case where the pixel values A, B, C, D, I, J, K, L, and M are “available”. In this case, the predicted pixel values of the pixels a to p are generated as in the following expression (14).

The predicted pixel value of the pixel a=(A+B+1)>>1

The predicted pixel value of the pixels b and i=(B+C+1)>>1

The predicted pixel value of the pixels c and j=(C+D+1)>>1

The predicted pixel value of the pixels d and k=(D+E+1)>>1

The predicted pixel value of the pixel l=(E+F+1)>>1

The predicted pixel value of the pixel e=(A+2B+C+2)>>2

The predicted pixel value of the pixels f and m=(B+2C+D+2)>>2

The predicted pixel value of the pixels g and n=(C+2D+E+2)>>2

The predicted pixel value of the pixels h and o=(D+2E+F+2)>>2

The predicted pixel value of the pixel p=(E+2F+G+2)>>2 (14)

The mode 8 is Horizontal_Up Prediction is applied only in a case where the pixel values A, B, C, D, I, J, K, L, and M are “available”. In this case, the predicted pixel values of the pixels a to p are generated as in the following expression (15).

The predicted pixel value of the pixel a=(I+J+1)>>1

The predicted pixel value of the pixel b=(I+2J+K+2)>>2

The predicted pixel value of the pixels c and e=(J+K+1)>>1

The predicted pixel value of the pixels d and f=(J+2K+L+2)>>2

The predicted pixel value of the pixels g and i=(K+L+1)>>1

The predicted pixel value of the pixels h and j=(K+3L+2)>>2

The predicted pixel value of the pixels k, l, m, n, o, and p=L (15)

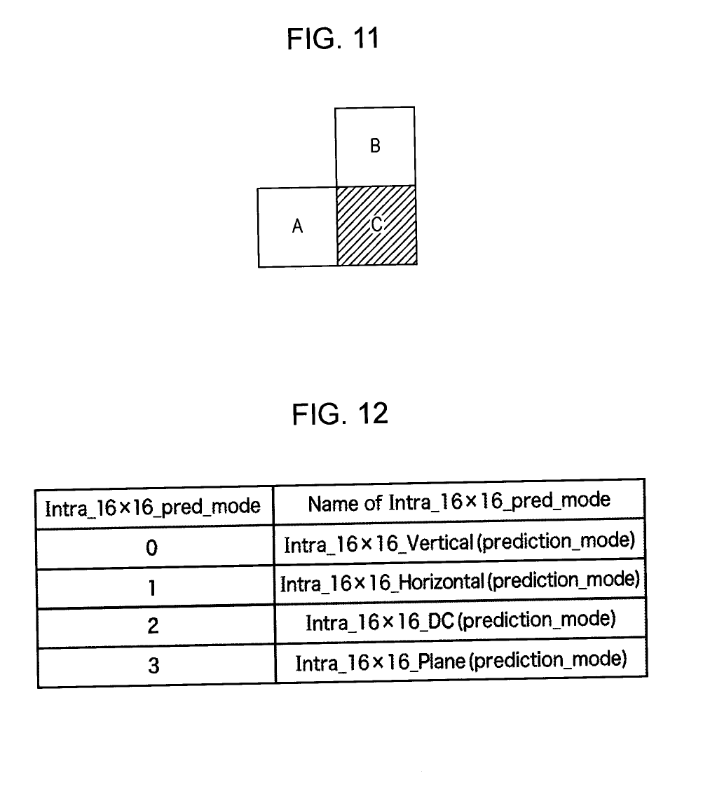

Next, with reference to FIG. 11, the encoding system in the 4×4 pixel intra prediction mode (Intra_{—}4×4_pred_mode) of the luminance signal will be described.

In an example of FIG. 11, a target block C that is composed of 4×4 pixels and becomes an encoding target is illustrate, and a block A and a block B which are composed of 4×4 pixels adjacent to the target block C are illustrated.

In this case, it is conceivable that Intra_{—}4×4_pred_mode in the target block C and Intra_{—}4×4_pred_mode in the block A and the block B have a high correlation. With use of this correlativity, by performing the encoding processing in the following manner, it is possible to realize a still higher encoding efficiency.

That is, In the example of FIG. 11, while those of Intra_{—}4×4_pred_mode in the block A and the block B are set respectively as Intra_{—}4×4_pred_mode A and Intra_{—}4×4_pred_mode B, MostProbableMode is defined as the following expression (16).

MostProbableMode=Min(Intra_{—}4×4_pred_mode A, Intra_{—}4×4_pred_mode B) (16)

That is, among the block A and the block B, one having the smaller mode_number allocated is set as MostProbableMode.

In a bit stream, as a parameter with respect to the target block C, two values of prev_intra4×4_pred_mode_flag[luma4×4BlkIdx] and rem_intra4×4_pred_mode[luma4×4BlkIdx] are defined, and through a processing based on a pseudo-code illustrated in the following expression (17), a decoding processing is performed, so that the values of Intra_{—}4×4_pred_mode and Intra4×4PredMode[luma4×4BlkIdx] with respect to the target block C can be obtained.

```
  if(prev_intra4x4_pred_mode_flag[luma4x4BlkIdx])
    Intra4x4PredMode[luma4x4BlkIdx] = MostProbableMode
  else
    if(rem_intra4x4_pred_mode]luma4x4BlkIdx] <
MostProbableMode)
  Intra4x4PredMode[luma4x4BlkIdx]=rem_intra4x4_pred_mode[
luma4x4BlkIdx]
  else
  Intra4x4PredMode[luma4x4BlkIdx]=rem_intra4x4_pred_mode[
luma4x4BlkIdx] + 1
. . . (17)
```

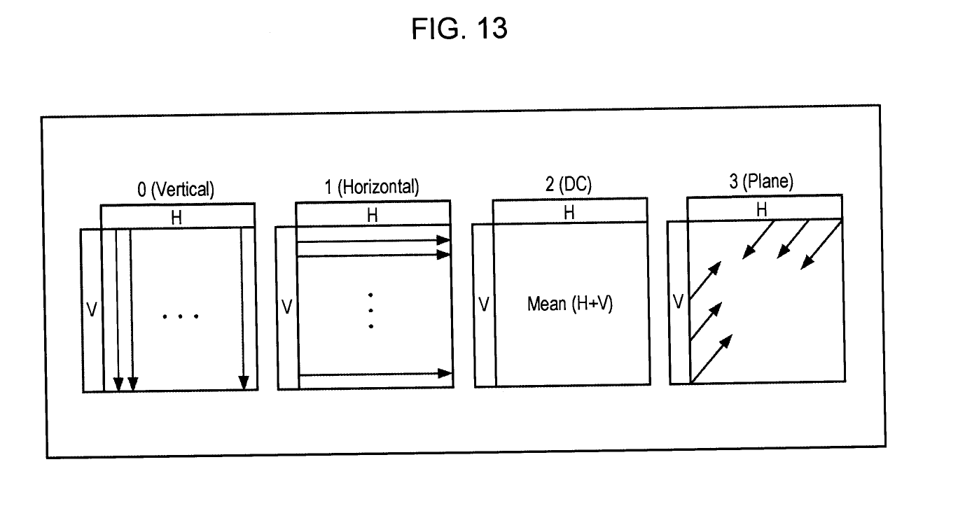

Next, the 16×16 pixel intra prediction mode will be described. FIG. 12 and FIG. 13 illustrate four types of 16×16 pixel intra prediction modes of the luminance signal (Intra_{—}16×16_pred_mode).

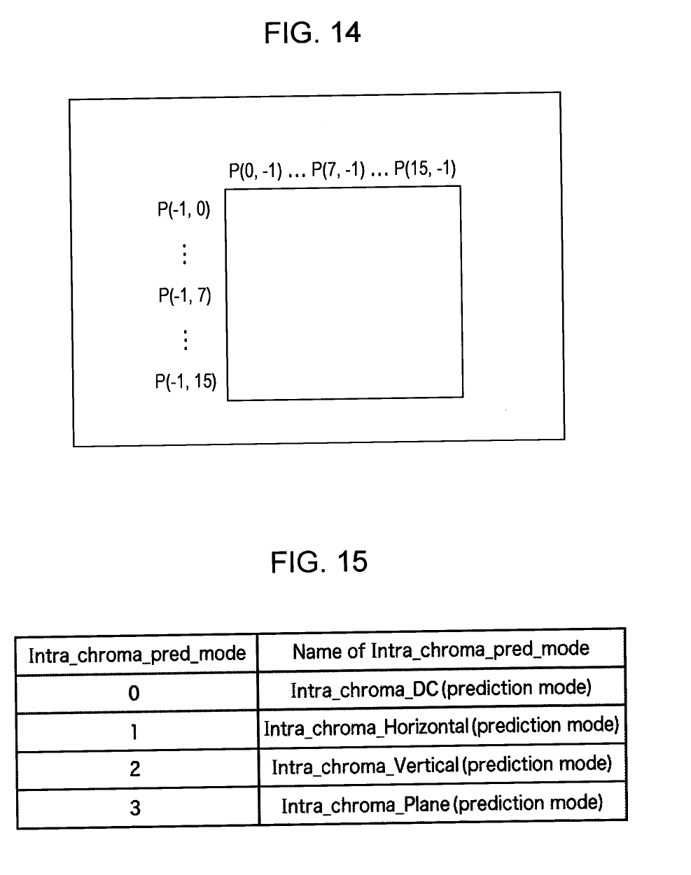

Four types of the pixel intra prediction mode will be described with reference to FIG. 14. In an example of FIG. 14, a target macro block A to be subjected to the intra processing is illustrated, and P(x,y); x,y=−1, 0, . . . , 15 represents a pixel value of the pixels adjacent to the target macro block A.

The mode 0 is Vertical Prediction and is applied only when P(x,−1); x,y=−1, 0, . . . , 15 is “available”. In this case, a predicted pixel value Pred(x,y) of the respective pixels in the target macro block A is generated as in the following expression (18).

Pred(x,y)=P(x,−1); x,y=0, . . . , 15 (18)

The mode 1 is Horizontal Prediction and is applied only when P(−1,y); x,y=−1, 0, . . . , 15 is “available”. In this case, the predicted pixel value Pred(x,y) of the respective pixels in the target macro block A is generated as in the following expression (19).

Pred(x,y)=P(−1,y); x,y=0, . . . , 15 (19)

The mode 2 is DC Prediction and is applied in a case where P(x,−1) and P(−1,y); x,y=−1, 0, . . . , 15 are all “available”, the predicted pixel value Pred(x,y) of the respective pixels in the target macro block A is generated as in the following expression (20).

$$\begin{matrix}[ Formula 5 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with x , y = 0 , … , 15 & ( 20 )\end{matrix}$$

Also, in a case where P(x,−1); x,y=−1, 0, . . . , 15 is “unavailable”, the predicted pixel value Pred(x,y) of the respective pixels in the target macro block A is generated as in the following expression (21).

$$\begin{matrix}[ Formula 6 ] & \\ Pred ( x , y ) = [ {\sum }_{{y}^{′} = 0}^{15} P ( - 1 , {y}^{′ } ) + 8 ] >> 4 \\ with x , y = 0 , … , 15 & ( 21 )\end{matrix}$$

In a case where P(−1,y); x,y=−1, 0, . . . , 15 is “unavailable”, the predicted pixel value Pred(x,y) of the respective pixels in the target macro block A is generated as in the following expression (22).

$$\begin{matrix}[ Formula 7 ] & \\ Pred ( x , y ) = [ {\sum }_{{y}^{′} = 0}^{15} P ( {x}^{′} , - 1 ) + 8 ] >> 4 \\ with x , y = 0 , … , 15 & ( 22 )\end{matrix}$$

In a case where P(x,−1) and P(−1,y); x,y=−1, 0, . . . , 15 are all “unavailable”, 128 is used as the predicted pixel value.

The mode 3 is Plane Prediction and is applied only in a case where P(x,−1) and P(−1,y); x,y=−1, 0, . . . , 15 are all “available”. In this case, the predicted pixel value Pred(x,y) of the respective pixels in the target macro block A is generated as in the following expression (23).

$$\begin{matrix}[ Formula 8 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {{\sum }_{y = 1}}^{8} y \cdot ( P ( - 1 , 7 + y ) - P ( - 1 , 7 - y ) ) & ( 23 )\end{matrix}$$

Next, the intra prediction mode with respect to a color difference signal will be described. FIG. 15 illustrates four types of the intra prediction modes of the color difference signal (Intra_chroma_pred_mode). The intra prediction modes of the color difference signal can be set independently from the intra prediction modes of the luminance signal. The intra prediction mode with respect to the color difference signal is pursuant to the above-mentioned 16×16 pixel intra prediction mode of the luminance signal.

It should be however noted that the 16×16 pixel intra prediction mode of the luminance signal targets the 16×16 pixel block, and on the other hand the intra prediction mode with respect to the color difference signal targets the 8×8 pixel block. Furthermore, as illustrated in FIG. 12 and FIG. 15 described above, mode numbers do not correspond between both sides.

With reference to FIG. 14, while being pursuant to the definitions of the pixel value in the target macro block A of the above-mentioned 16×16 pixel intra prediction mode of the luminance signal and the pixel value of the adjacent pixel value, a pixel value of a pixel adjacent to the target macro block A subjected to the intra processing (in the case of the color difference signal, 8×8 pixels) is set as P(x,y); x,y=−1, 0, . . . , 7.

In a case where the mode 0 is DC Prediction and P(x,−1) and P(−1,y); x,y=−1, 0, . . . , 7 are all “available”, the predicted pixel value Pred(x,y) of the respective pixels in the target macro block A is generated as in the following expression (24).

$$\begin{matrix}[ Formula 9 ] & \\ Pred ( x , y ) = ( ( {\sum }_{n = 0}^{7} ( P ( - 1 , n ) + P ( n , - 1 ) ) ) + 8 ) >> 4 \\ with x , y = 0 , … , 7 & ( 24 )\end{matrix}$$

Also, in a case where P(−1,y); x,y=−1, 0, . . . , 7 is “unavailable”, the predicted pixel value Pred(x,y) of the respective pixels in the target macro block A is generated as in the following expression (25).

$$\begin{matrix}[ Formula 10 ] & \\ Pred ( x , y ) = [ ( {\sum }_{n = 0}^{7} P ( n , - 1 ) ) + 4 ] >> 3 \\ with x , y = 0 , … , 7 & ( 25 )\end{matrix}$$

Also, in a case where P(x,−1); x,y=−1, 0, . . . , 7 is “unavailable”, the predicted pixel value Pred(x,y) of the respective pixels in the target macro block A is generated as in the following expression (26).

$$\begin{matrix}[ Formula 11 ] & \\ Pred ( x , y ) = [ ( {\sum }_{n = 0}^{7} P ( - 1 , n ) ) + 4 ] >> 3 \\ with x , y = 0 , … , 7 & ( 26 )\end{matrix}$$

It is applied only in a case where the mode 1 is Horizontal Prediction and P(−1,y); x,y=−1, 0, . . . , 7 is “available”. In this case, the predicted pixel value Pred(x,y) of the respective pixels in the target macro block A is generated as in the following expression (27).

Pred(x,y)=P(−1,y); x,y=0, . . . , 7 (27)

It is applied only in a case where the mode 2 is Vertical Prediction and P(x,−1); x,y=−1, 0, . . . , 7 is “available”. In this case, the predicted pixel value Pred(x,y) of the respective pixels in the target macro block A is generated as in the following expression (28).

Pred(x,y)=P(x,−1); x,y=0, . . . , 7 (28)

It is applied only in a case where the mode 3 is Plane Prediction and P(x,−1) and P(−1,y); x,y=−1, 0, . . . , 7 are all “available”. In this case, the predicted pixel value Pred(x,y) of the respective pixels in the target macro block A is generated as in the following expression (29).

$$\begin{matrix}[ Formula 12 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 29 )\end{matrix}$$

As described above, the intra prediction modes of the luminance signal include prediction modes of nine types of 4×4 pixel and 8×8 pixel block units and four types of 16×16 pixel macro block unit, and the intra prediction modes of the color difference signal include prediction modes of four types of 8×8 pixel block units. The intra prediction modes of the color difference signal can be set independently from the intra prediction modes of the luminance signal. With regard to the 4×4 pixel and 8×8 pixel intra prediction modes of the luminance signal, one pixel intra prediction mode is defined for each block of the luminance signal of 4×4 pixels and 8×8 pixels. With regard to the 16×16 pixel intra prediction mode of the luminance signal and the intra prediction modes of the color difference signal, one prediction mode is defined with respect to one macro block.

It should be noted that types of the prediction modes correspond to directions indicated by numbers 0, 1, and 3 to 8 of FIG. 9 described above. The prediction mode 2 is an average value prediction.

Next, the intra prediction processing in step S31 of FIG. 5 which is a processing performed with respect to these prediction modes will be described with reference to a flow chart of FIG. 16. It should be noted that in an example of FIG. 16, a case of the luminance signal will be described as an example.

The intra prediction unit 74 performs the intra prediction with respect to the respective intra prediction modes of 4×4 pixels, 8×8 pixels, and 16×16 pixels of the above-mentioned luminance signal in step S41.

For example, the case of the 4×4 pixel intra prediction mode will be described with reference to FIG. 10 described above. In a case where the processing target image read out from the screen sorting buffer 62 (for example, the pixels a to p) is an image in a block to be subjected to the intra processing, a decoded image to be referred to (pixels indicating the pixel values A to M) is read out from the frame memory 72 and supplied via the switch 73 to the intra prediction unit 74.

On the basis of these images, the intra prediction unit 74 performs the intra prediction on the processing target block pixels. While this intra prediction processing is performed in the respective intra prediction modes, predicted images are generated in the respective intra prediction modes. It should be noted that as the decoded pixels to be referred to (pixels indicating the pixel values A to M), the pixels that are not subjected to the deblock filtering by the deblock filter 71 are used.

The intra prediction unit 74 calculates the cost function values with respect to the respective intra prediction modes of 4×4 pixels, 8×8 pixels, and 16×16 pixels in step S42. Herein, this is performed on the basis of any of High Complexity mode or Low Complexity mode for the cost function value as set by JM (Joint Model) that is reference software in the H.264/AVC system.

That is, in the High Complexity mode, as a processing in step S41, with respect to all the candidate prediction modes, up to the encoding processing is temporarily performed, the cost function value represented by the following expression (30) is calculated with respect to the respective prediction modes, and selects the prediction mode where the smallest value is given as the optimal prediction mode.

Cost(Mode)=D+λ·R (30)

D denotes a difference (distortion) between the original image and the decoded image, R denotes a generated bit rate including up to an orthogonal transform coefficient, and λ denotes a Lagrange multiplier given as a function of a quantization parameter QP.

On the other hand, in the Low Complexity mode, as a processing in step S41, with respect to all the candidate prediction modes, a predicted image is generated, and, up to the header bits such as the motion vector information and the prediction mode information are calculated, the cost function value represented by the following expression (31) is calculated with respect to the respective prediction modes, and the prediction mode where the smallest value is given is selected as the optimal prediction mode.

Cost(Mode)=D+QPtoQuant(QP)·Header_Bit (31)

D denotes a difference (distortion) between the original image and the decoded image, Header_Bit denotes a header bit with respect to the prediction mode, and QPtoQuant denotes a Lagrange multiplier given as a function of the quantization parameter QP.

In the Low Complexity mode, with respect to all the prediction modes, the predicted image is only generated, and it is not necessary to perform the encoding processing and the decoding processing, so that the computation amount can be small.

The intra prediction unit 74 respectively decides optimal modes with respect to the respective intra prediction modes of 4×4 pixels, 8×8 pixels, and 16×16 pixels in step S43. That is, as described above with reference to FIG. 9, in the case of the intra 4×4 prediction mode and the intra 8×8 prediction mode, nine types exist for the types of the prediction mode, and in the case of the intra 16×16 prediction mode, four types exist for the types of the prediction mode. Therefore, on the basis of the cost function values calculated in step S42, among those, the intra prediction unit 74 decides an optimal intra 4×4 prediction mode, an optimal intra 8×8 prediction mode, and an optimal intra 16×16 prediction mode.

In step S44, among the respective optimal modes decided with respect to the respective intra prediction modes of 4×4 pixels, 8×8 pixels, and 16×16 pixels, on the basis of the cost function values calculated in step S42, the intra prediction unit 74 selects one pixel intra prediction mode. That is, among the respective optimal modes decided with respect to 4×4 pixels, 8×8 pixels, and 16×16 pixels, the intra prediction mode where the cost function value is the smallest value is selected.

Next, the intra template Weighted Prediction system will be described.

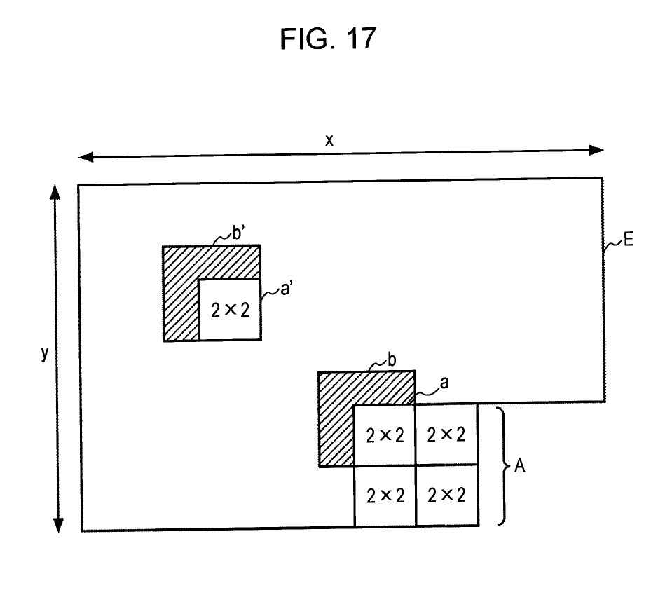

First, Next, with reference to FIG. 17, the intra template matching system will be described.

In an example of FIG. 17, on a target frame of an encoding target which is not illustrated in the drawing, a predetermined search range E which is only composed of already encoded pixels among the block A of 4×4 pixels and an area composed of X×Y (=vertical×horizontal) pixels is illustrated.

In the block A, a target sub block a to be encoded after this is illustrated. This target sub block a is a sub block located on the upper left among sub blocks of 2×2 pixels constituting the block A. To the target block a, a template area b composed of already encoded pixels is adjacent. That is, in a case where the encoding processing is performed in a raster scan order, as illustrated in FIG. 17, the template area b is an area located on the left of the target sub block a and on the upper side and is an area where decoded images are accumulated in the frame memory 72.

In the predetermined search area E on the target frame, for example, the intra TP matching unit 75 performs a template matching processing by using SAD (Sum of Absolute Difference) or the like as a cost function and searches for a motion vector with respect to the target block a by using a block a′ corresponding to an area b′ where a correlation with the pixel value of the template area b is the highest as a predicted image with respect to the target sub block a.

In this manner, as the motion vector search processing based on the intra template matching system uses the decoded image for the template matching processing, by previously setting the predetermined search area E, it is possible to perform the same processing in the image encoding apparatus 51 of FIG. 1 and an image decoding apparatus which will be described below. That is, in the image decoding apparatus too, by constituting an intra TP matching unit, as it is not necessary to sent the information on the motion vector with respect to the target sub block A to the image decoding apparatus, it is possible to reduce the motion vector information within the compressed image.

It should be noted that in FIG. 17, the case where the target sub block is 2×2 pixels has been described, but without limiting to this, it is possible to apply to a sub block of an arbitrary size, and the sizes of the block and the template in the intra template prediction mode are arbitrary. That is, similarly as in the intra prediction unit 74, it is possible to perform the intra template matching processing while the block sizes in the respective intra prediction modes are set as the candidate, and also it is possible to perform while one prediction mode is fixed to the block size. In accordance with the block size that becomes the target, the template size may be set variable or can also be fixed.

In the intra template Weighted Prediction system, by referring to the matching result by the above-mentioned intra template matching system, the Weighted Prediction is performed as in the following manner, and a predicted image is generated.

It should be noted that the Weighted Prediction includes two methods of a method using a weighting factor and a method using an offset value, and either method may be used.

According to the method using the weighting factor, the weighting factor calculation unit 76 calculates an average value of the pixels of the template area b, the area b′ (FIG. 17) in the intra template matching system to be respectively set as Ave (Cur_tmplt) and Ave (Ref_tmplt). Then, the weighting factor calculation unit 76 uses the average values Ave (Cur_tmplt) and Ave (Ref_tmplt) to calculate a weighting factor w₀ by the following expression (32).

$$\begin{matrix}[ Formula 13 ] & \\ {w}_{0} = \frac{Ave ( Cur\_tmplt )}{Ave ( Ref\_tmplt )} & ( 32 )\end{matrix}$$

According to the expression (32), the weighting factor w₀ becomes different values with respect to the respective template matching blocks.

The intra TP matching unit 75 uses this weighting factor w₀ and a pixel value Ref of the block a′ to calculate the predicted pixel value Pred(Cur) of the block a by the following expression (33).

Pred(Cur)=w₀×Ref (33)

It should be noted that the predicted pixel value Pred(Cur) calculated by the expression (33) is subjected to a clip processing so as to take a value in a range from 0 to an upper limit value that may be taken as a pixel value of an input image. For example, in a case where the input image is an 8-bit accuracy, the predicted pixel value Pred(Cur) is clipped in a range from 0 to 255.

Also, the weighting factor w₀ calculated by the expression (32) may be approximated to a value represented in an X/(2ⁿ) format. In this case, as division can be performed by bit shift, the computation amount in the Weighted Prediction processing can be reduced.

On the other hand, according to the method using the offset value, the weighting factor calculation unit 76 uses the average values Ave (Cur_tmplt) and Ave (Ref_tmplt) to calculate an offset value d₀ by the following expression (34).

d₀=Ave(Cur_tmplt)−Ave(Ref_tmplt) (34)

According to the expression (34), the offset value d₀ becomes different values with respect to the respective template matching blocks.

The intra TP matching unit 75 uses this offset value d₀ and the pixel value Ref to calculate the predicted pixel value Pred(Cur) of the block a by the following expression (35).

Pred(Cur)=Ref+d₀ (35)

It should be noted that the predicted pixel value Pred(Cur) calculated by the expression (35) is subjected to a clip processing so as to take a value in a range from 0 to an upper limit value that may be taken as a pixel value of an input image. For example, in a case where the input image is an 8-bit accuracy, the predicted pixel value Pred(Cur) is clipped in a range from 0 to 255.

As described above, in the intra template Weighted Prediction system, a predicted image is generated through the Weighted Prediction. Therefore, in the same texture area within the screen, due to the factor such as gradation, in a case where the luminance has a change, the prediction error caused by the change is decreased, and as compared with the intra template matching system, it is possible to improve the encoding efficiency.

Also, as the weighting factor w₀ and the offset d₀ used in the Weighted Prediction can be calculated in the respective template matching block units, it is possible to perform the Weighted Prediction on the basis of a local characteristic of the image. As a result, it is possible to further improve the encoding efficiency.

It should be noted that as the motion prediction/compensation system, whether the intra template Weighted Prediction system is adopted or the intra template system is adopted may be decided in the picture (slice) units or may be decided in the macro block units or the template matching block units.

Also, in a case where the motion prediction/compensation system is decided in the macro block/template matching block units, only when the motion prediction/compensation systems for the target macro block/template matching block and the adjacent macro block/template matching block are different from each other, the template system information may be inserted to the header part. In this case, the information amount of the header part can be reduced.

Furthermore, as described above, the weighting factor or the offset value used in Weighted Prediction may be set by using the pixel value of the template area b in a heuristic manner but may be inserted to the compressed image and transmitted like Explicit Weighted Prediction in AVC.

Next, with reference to a flow chart of FIG. 18, the intra template motion prediction processing in step S32 of FIG. 5 will be described.

In step S51, the intra TP matching unit 75 performs the motion vector search in the intra template matching system.

In step S52, the intra TP matching unit 75 determines whether the intra template Weighted Prediction system is adopted or not as the system for the motion prediction/compensation processing.

In step S52, in a case where it is determined that the intra template Weighted Prediction system is adopted as the system for the motion prediction/compensation processing, the intra TP matching unit 75 supplies the image supplied from the intra prediction unit 74 to the weighting factor calculation unit 76. Then, in step S53, the weighting factor calculation unit 76 uses the image supplied from the intra TP matching unit 75 to calculate the weighting factor.

To be more specific, the weighting factor calculation unit 76 uses the decoded images in the template area b and the area b′ to calculate the weighting factor by the above-mentioned expression (32). It should be noted that the weighting factor calculation unit 76 may calculate the offset value by the above-mentioned expression (34) by using the decoded images in the template area b and the area b′.

In step S54, the intra TP matching unit 75 uses the weighting factor calculated in step S53 by the above-mentioned expression (33). It should be noted that in a case where the offset value is calculated by the weighting factor calculation unit 76, the intra TP matching unit 75 generates a predicted image by the above-mentioned expression (35).

On the other hand, in step S52, in a case where it is determined that the intra template Weighted Prediction system is not adopted as the system for the motion prediction/compensation processing, that is, in a case where the intra template system is adopted as the system for the motion prediction/compensation processing, the processing proceeds to step S55.

In step S55, the intra TP matching unit 75 generates a predicted image on the basis of the motion vectors searched for in step S51. For example, on the basis of the motion vectors, the intra TP matching unit 75 sets the image in the area a′ as the predicted image as it is.

After the processing in step S54 or S55, in step S56, the intra TP matching unit 75 calculates a cost function value with respect to the intra template prediction mode.

In this manner, the intra template motion prediction processing is carried out.

Next, with reference to a flow chart of FIG. 19, the inter motion prediction processing in step S34 of FIG. 5 will be described.

In step S71, with respect to the eight types of the respective inter prediction modes composed of 16×16 pixels to 4×4 pixels described above with reference to with respect to FIG. 2, the motion prediction/compensation unit 77 respectively decides the motion vectors and the reference images. That is, the motion vectors and the reference images are respectively decided for the processing target blocks in the respective inter prediction modes.

In step S72, with regard to the eight types of the respective inter prediction modes composed of 16×16 pixels to 4×4 pixels, on the basis of the motion vectors decided in step S71, the motion prediction/compensation unit 77 performs the motion prediction and compensation processing on the reference images. Through this motion prediction and compensation processing, predicted images in the respective inter prediction modes are generated.

In step S73, with regard to the motion vectors decided with respect to the eight types of the respective inter prediction modes composed of 16×16 pixels to 4×4 pixels, the motion prediction/compensation unit 77 generates motion vector information to be added to the compressed image.

Herein, with reference to a FIG. 20, the generation method for the motion vector information in the H.264/AVC system will be described. In an example of FIG. 20, the target block E to be encoded after this (for example, 16×16 pixels) and the already encoded block A to D adjacent to the target block E are illustrated.

That is, the block D is adjacent on the upper left of the target block E, the block B is adjacent on the upper part of the target block E, the block C is adjacent on the upper right of the target block E, and the block A is adjacent on the left of the target block E. It should be noted that a state in which the block A to D are not sectioned represents that these are respectively a block of one of the configurations among 16×16 pixels to 4×4 pixels described above in FIG. 2.

For example, the motion vector information with respect to X (=A, B, C, D, E) is represented by mvX. First, predicted motion vector information (predicted value of the motion vector) pmvE with respect to the target block E can be obtained by using the motion vector information with regard to the blocks A, B, and C by the following expression (36) through a median operation.

pmvE=med(mvA,mvB,mvC) (36)

In a case where the motion vector information with regard to the block C is not usable (is unavailable) due to a reason of being at an end of the image frame, not being encoded yet, or the like, the motion vector information with regard to the block C is substituted by the motion vector information with regard to the block D.

As the motion vector information with respect to the target block E, data mvdE added to the header part of the compressed image is calculated by the following expression (37) by using pmvE.

mvdE=mvE−pmvE (37)

It should be noted that in actuality, the processing is independently performed on respective components in the horizontal direction and the vertical direction of the motion vector information.

In this manner, the predicted motion vector information is generated, and by adding the difference between the predicted motion vector information generated by the correlation with the adjacent block and the motion vector information to the header part of the compressed image, the motion vector information can be reduced.

The thus generated motion vector information is also used at the time of a cost function value calculation in the next step S74, and eventually output together with information representing the inter prediction mode (hereinafter, which will be appropriately referred to as inter prediction mode information) and reference frame information to the lossless encoding unit 66 in a case where the corresponding predicted image is selected by the predicted image selection unit 78.

While referring back to FIG. 19, in step S74, the motion prediction/compensation unit 77 calculates the cost function values indicated by the above-mentioned expression (30) or the expression (31) with respect to the eight types of respective inter prediction modes composed of 16×16 pixels to 4×4 pixels. The cost function values calculated herein are used at the time of selecting the optimal inter prediction mode in step S35 of FIG. 5 described above.

It should be noted that the calculation of the cost function value with respect to the inter prediction mode also includes an evaluation of the cost function value in Skip Mode and Direct Mode set by the H.264/AVC system.

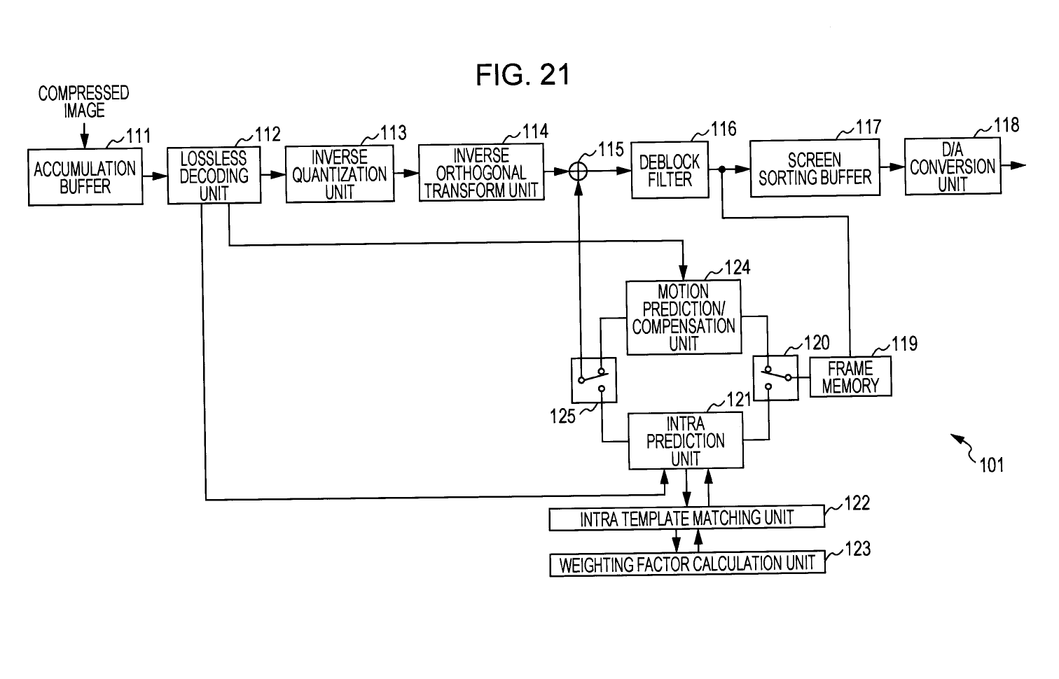

Also, the compressed image encoded by the image encoding apparatus 51 is transmitted via a predetermined transmission path and decoded by the image decoding apparatus. FIG. 21 illustrates a configuration of an embodiment of such an image decoding apparatus.

An image decoding apparatus 101 is composed of an accumulation buffer 111, a lossless decoding unit 112, an inverse quantization unit 113, an inverse orthogonal transform unit 114, a computation unit 115, a deblock filter 116, a screen sorting buffer 117, a D/A conversion unit 118, a frame memory 119, a switch 120, an intra prediction unit 121, an intra template matching unit 122, a weighting factor calculation unit 123, a motion prediction/compensation unit 124, and a switch 125.

It should be noted that hereinafter, the intra template matching unit 122 will be referred to as intra TP matching unit 122.

The accumulation buffer 111 accumulates the transmitted compressed images. The lossless decoding unit 112 decodes the information supplied from the accumulation buffer 111 and encoded by the lossless encoding unit 66 of FIG. 1 in a system corresponding to the encoding system of the lossless encoding unit 66. The inverse quantization unit 113 performs inverse quantization on the image decoded by the lossless decoding unit 112 in a system corresponding to the quantization system of the quantization unit 65 of FIG. 1. The inverse orthogonal transform unit 114 performs inverse orthogonal transform on the output of the inverse quantization unit 113 in a system corresponding to the orthogonal transform of the orthogonal transform unit 64 of FIG. 1.

The output after the inverse orthogonal transform is decoded while being added with the predicted image supplied from the switch 125 by the computation unit 115. After the block distortion of the decoded image is removed, the deblock filter 116 supplies it to the frame memory 119 and also outputs it to the screen sorting buffer 117.

The screen sorting buffer 117 sorts the images. That is, the order of the frames sorted for the order for the encoding by the screen sorting buffer 62 of FIG. 1 is sorted into the original display order. The D/A conversion unit 118 performs D/A conversion on the image supplied from the screen sorting buffer 117 to be output to a display that is not illustrated in the drawing and displayed.

The switch 120 reads out the image where the inter coding is performed and the image to be referred to from the frame memory 119 to be output to the motion prediction/compensation unit 124 and also reads out the image used for the intra prediction from the frame memory 119 to be supplied to the intra prediction unit 121.

To the intra prediction unit 121, information obtained by decoding the header information (prediction mode information, template system information, or the like) is supplied from the lossless decoding unit 112. As the prediction mode information, in a case where the intra prediction mode information is supplied, the intra prediction unit 121 generates a predicted image on the basis of this intra prediction mode information.

As the prediction mode information, in a case where the intra template prediction mode information is supplied, the intra prediction unit 121 supplies the image read from the frame memory 119 to the intra TP matching unit 122 to carry out the motion prediction/compensation processing in the intra template prediction mode. It should be noted that At this time, the template system information supplied from the lossless decoding unit 112 is also supplied to the intra TP matching unit 122.

Also, in accordance with the prediction mode information, the intra prediction unit 121 outputs either the predicted image generated in the intra prediction mode or the predicted image generated in the intra template prediction mode to the switch 125.

In accordance with the template system information supplied from the intra prediction unit 121, similarly as in the intra TP matching unit 75 of FIG. 1, the intra TP matching unit 122 performs the motion prediction and compensation processing in the intra template prediction mode. That is, on the basis of the image supplied from the intra prediction unit 121, in the intra template Weighted Prediction system or the intra template matching system, the intra TP matching unit 122 performs the motion prediction and compensation processing in the intra template prediction mode. As a result, a predicted image is generated.

It should be noted that in a case where the motion prediction and compensation processing is performed in the intra template Weighted Prediction system, the intra TP matching unit 122 supplies the images in the template area b in the intra template matching system and in the area b′ within the search range E where the correlation with the template area is the highest to the weighting factor calculation unit 123. Then, in accordance with the image, by using the weighting factor or the offset value supplied from the weighting factor calculation unit 123, similarly as in the intra TP matching unit 75 of FIG. 1, the intra TP matching unit 122 generates a predicted image.

The predicted image generated through the motion prediction/compensation in the intra template prediction mode is supplied to the intra prediction unit 121.

From the images in the template area b and the area b′ which are supplied from the intra TP matching unit 122, similarly as in the weighting factor calculation unit 76 of FIG. 1, the weighting factor calculation unit 123 calculates the weighting factor or the offset value to be supplied to the intra TP matching unit 122.

The motion prediction/compensation unit 124 is supplied with the information obtained by decoding the header information (the prediction mode information, the motion vector information, the reference frame information, or the like) from the lossless decoding unit 112. As the prediction mode information, in a case where the inter prediction mode information is supplied, the motion prediction/compensation unit 124 applies the motion prediction and compensation processing on the image on the basis of the motion vector information and the reference frame information to generate a predicted image.

The switch 125 selects the predicted image generated by the motion prediction/compensation unit 124 or the intra prediction unit 121 to be supplied to the computation unit 115.

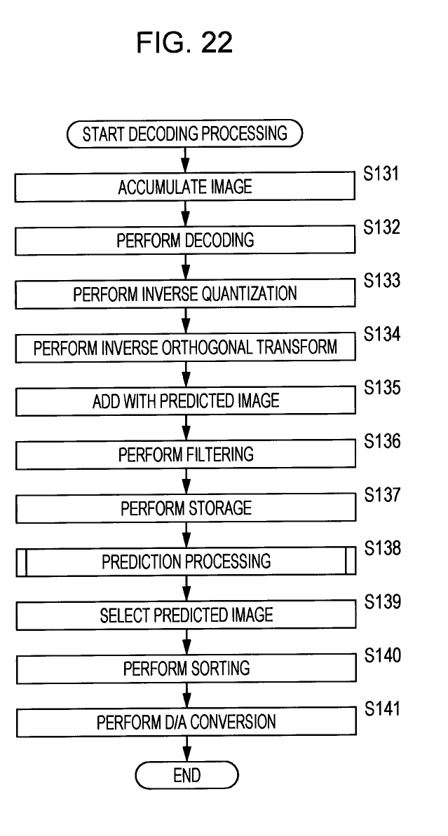

Next, with reference to a flow chart of FIG. 22, the decoding processing executed by the image decoding apparatus 101 will be described.

In step S131, the accumulation buffer 111 accumulates the transmitted images. In step S132, the lossless decoding unit 112 decodes the compressed image supplied from the accumulation buffer 111. That is, the I picture, the P picture, and the B picture encoded by the lossless encoding unit 66 of FIG. 1 are decoded.

At this time, the motion vector information or the prediction mode information (information representing the intra prediction mode, the inter prediction mode, or the intra template prediction mode) is also decoded. That is, in a case where the prediction mode information represents the intra prediction mode or the intra template prediction mode, the prediction mode information is supplied to the intra prediction unit 121. At that time, if the corresponding template system information exists, that is also supplied to the intra prediction unit 121. Also, in a case where the prediction mode information represents the inter prediction mode, the prediction mode information is supplied to the motion prediction/compensation unit 124. At that time, if the corresponding motion vector information, reference frame information, or the like exists, that is also supplied to the motion prediction/compensation unit 124.

In step S133, the inverse quantization unit 113 inversely quantizes the transform coefficient decoded by the lossless decoding unit 112 in accordance with a characteristic corresponding to the characteristic of the quantization unit 65 of FIG. 1. In step S134, the inverse orthogonal transform unit 114 performs inverse orthogonal transform on the transform coefficient inversely quantized by the inverse quantization unit 113 in a characteristic corresponding to a characteristic of the orthogonal transform unit 64 of FIG. 1. According to this, the difference information corresponding to an input of the orthogonal transform unit 64 of FIG. 1 (output of the computation unit 63) is decoded.

In step S135, the computation unit 115 adds the predicted image selected in a processing in step S139 which will be described below and input via the switch 125 with the difference information. According to this, the original image is decoded. In step S136, the deblock filter 116 filters the image output from the computation unit 115. According to this, the block distortion is removed. In step S137, the frame memory 119 stores the image subjected to the filtering.

In step S138, the intra prediction unit 121, the intra TP matching unit 122, or the motion prediction/compensation unit 124 respectively performs the prediction processing on the image while corresponding to the prediction mode information supplied from the lossless decoding unit 112.

That is, in a case where the intra prediction mode information is supplied from the lossless decoding unit 112, the intra prediction unit 121 performs the intra prediction processing in the intra prediction mode. Also, in a case where the intra template prediction mode information is supplied from the lossless decoding unit 112, the intra TP matching unit 122 performs the motion prediction/compensation processing in the intra template prediction mode. In a case where the inter prediction mode information is supplied from the lossless decoding unit 112, the motion prediction/compensation unit 124 performs the motion prediction/compensation processing in the inter prediction mode.

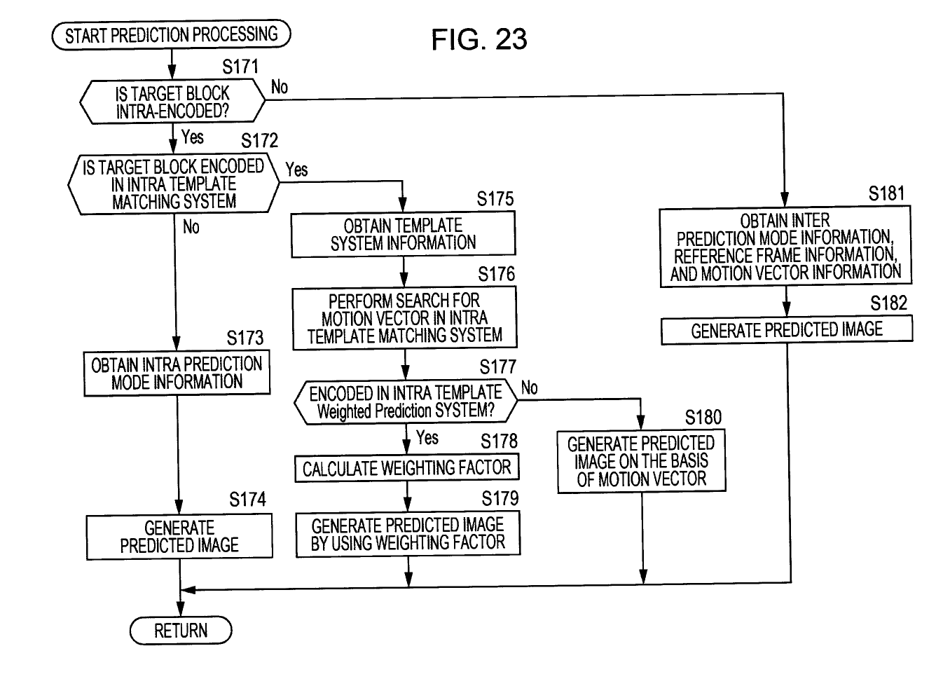

A detail of the prediction processing in step S138 will be described below with reference to FIG. 23, and with this processing, the predicted image generated by the intra prediction unit 121, the predicted image generated by the intra TP matching unit 122, or the predicted image generated by the motion prediction/compensation unit 124 is supplied to the switch 125.

In step S139, the switch 125 selects the predicted image. That is, as the predicted image generated by the intra prediction unit 121, the predicted image generated by the intra TP matching unit 122, or the predicted image generated by the motion prediction/compensation unit 124 is supplied, the supplied predicted image is selected and supplied to the computation unit 115 to be added with the output of the inverse orthogonal transform unit 114 in step S134 as described above.

In step S140, the screen sorting buffer 117 performs sorting. That is, the order of the frames sorted for the encoding by the screen sorting buffer 62 of the image encoding apparatus 51 is sorted into the original display order.

In step S141, the D/A conversion unit 118 performs D/A conversion on the image from the screen sorting buffer 117. This image is output to the display that is not illustrated in the drawing, and the image is displayed.

Next, with reference to a flow chart of FIG. 23, the prediction processing in step S138 of FIG. 22 will be described.

The intra prediction unit 121 determines whether or not the target block is subjected to the intra encoding in step S171. When the intra prediction mode information or the intra template prediction mode information is supplied from the lossless decoding unit 112 to the intra prediction unit 121, the intra prediction unit 121 determines that the target block is subjected to the intra encoding in step S171, and the processing proceeds to step S172.

The intra prediction unit 121 determines whether or not the target block is encoded in the intra template matching system in step S172. When the intra prediction mode information is supplied from the lossless decoding unit 112 to the intra prediction unit 121, the intra prediction unit 121 determines that the target block is not encoded in the intra template matching system in step S172, and the processing proceeds to step S173.

In step S173, the intra prediction unit 121 obtains the intra prediction mode information.

In step S174, the image necessary for the processing is read out from the frame memory 119, and also the intra prediction unit 121 performs the intra prediction to generate a predicted image while following the intra prediction mode information obtained in step S173. Then, the processing ends.

On the other hand, when the intra template prediction mode information is supplied from the lossless decoding unit 112 to the intra prediction unit 121, the intra prediction unit 121 determines that the target block is encoded in the intra template matching system in step S172, and the processing proceeds to step S175.

In step S175, the intra prediction unit 121 obtains the template system information from the lossless decoding unit 112 to be supplied to the intra TP matching unit 122. In step S176, the intra TP matching unit 122 performs the motion vector search in the intra template matching system.

In step S177, the intra TP matching unit 122 whether or not the target block is encoded in the intra template Weighted Prediction system. If the template system information obtained from the lossless decoding unit 112 represents that the intra template Weighted Prediction system is adopted as the motion prediction/compensation system, the intra TP matching unit 122 determines that the target block is encoded in the intra template Weighted Prediction system in step S177, and the processing proceeds to step S178.

In step S178, the weighting factor calculation unit 123 calculates the weighting factor by the above-mentioned expression (32). It should be noted that the weighting factor calculation unit 76 may calculate an offset value by the above-mentioned expression (34).

In step S179, the intra TP matching unit 122 generates a predicted image by using the weighting factor calculated in step S178 by the above-mentioned expression (33). It should be noted that in a case where the offset value is calculated by the weighting factor calculation unit 76, the intra TP matching unit 122 generate a predicted image by the above-mentioned expression (35). Then, the processing ends.

Also, if the template system information obtained from the lossless decoding unit 112 represents that the intra template system is adopted as the motion prediction/compensation system, in step S177, it is determined that the target block is not encoded in the intra template Weighted Prediction system, and the processing proceeds to step S180.

In step S180, the intra TP matching unit 122 generates a predicted image on the basis of the motion vectors searched for in step S176.

On the other hand, in step S171, in a case where it is determined that the target block is not subjected to the intra encoding, the processing proceeds to step S181. In this case, as the processing target image is an image subjected to the inter processing, the necessary image is read out from the frame memory 119 and supplied via the switch 120 to the motion prediction/compensation unit 124.

In step S181, the motion prediction/compensation unit 124 obtains the inter prediction mode information, the reference frame information, and the motion vector information from the lossless decoding unit 112.

In step S182, on the basis of the inter prediction mode information, the reference frame information, and the motion vector information obtained in step S181, the motion prediction/compensation unit 124 performs the motion prediction in the inter prediction mode and generates a predicted image. Then, the processing ends.

In this manner, the prediction processing is executed.

As described above, according to the present invention, in the image encoding apparatus and the image decoding apparatus, with regard to the image subjected to the intra prediction, the motion prediction is carried out in the intra template matching system where the motion search is performed by using the decoded image, and therefore without sending the motion vector information, it is possible to display a good-quality image quality.

It should be noted that in the above-mentioned explanation, the case has been described in which the size of the macro block is 16×16 pixels, but the present invention can also be applied with respect to the extended macro block size described in “Video Coding Using Extended Block Sizes”, VCEG-AD09, ITU-Telecommunications Standardization Sector STUDY GROUP Question 16—Contribution 123, January 2009.

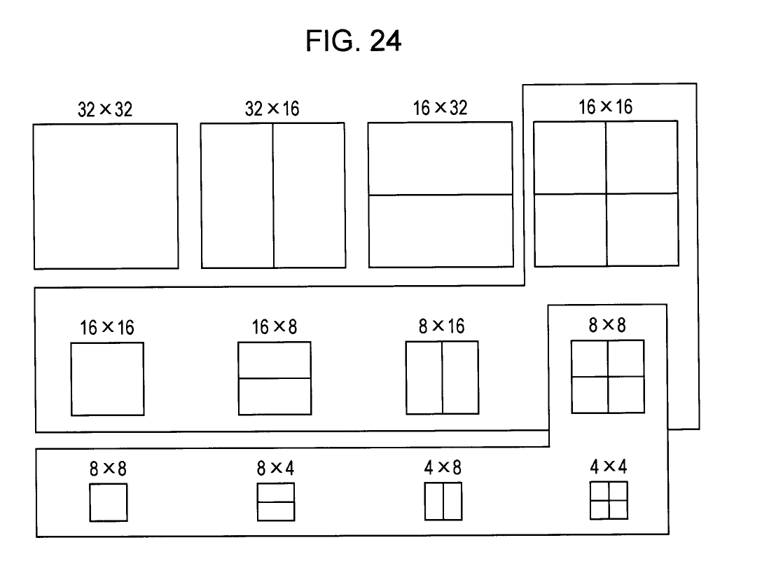

FIG. 24 illustrates an example of the extended macro block size. In the above-mentioned description, the macro block size is extended to 32×32 pixels.

On an upper stage of FIG. 24, from the left, the macro blocks composed of 32×32 pixels divided into blocks (partitions) of 32×32 pixels, 32×16 pixels, 16×32 pixels, and 16×16 pixels are sequentially illustrated. On a middle stage of FIG. 24, from the left, the blocks composed of 16×16 pixels divided into blocks of 16×16 pixels, 16×8 pixels, 8×16 pixels, and 8×8 pixels are sequentially illustrated. Also, on a lower stage of FIG. 24, from the left, the blocks of 8×8 pixels divided into blocks of 8×8 pixels, 8×4 pixels, 4×8 pixels, and 4×4 pixels are sequentially illustrated.

That is, in the macro block of 32×32 pixels, it is possible to perform a processing in the blocks of 32×32 pixels, 32×16 pixels, 16×32 pixels, and 16×16 pixels illustrated in the upper stage of FIG. 24.

Also, in the block of 16×16 illustrated on the right side of the upper stage, similarly as in the H.264/AVC system, it is possible to perform a processing in the blocks of 16×16 pixels, 16×8 pixels, 8×16 pixels, and 8×8 pixels illustrated in the middle stage.

Furthermore, in the block of 8×8 pixels illustrated on the right side of the middle stage, similarly as in the H.264/AVC system, it is possible to perform a processing in the blocks of 8×8 pixels, 8×4 pixels, 4×8 pixels, and 4×4 pixels illustrated in the lower stage.

By adopting such a hierarchy structure, in the extended macro block size, with respect to the blocks of 16×16 pixels or smaller, while maintaining the compatibility with the H.264/AVC system, as a super set thereof, a still larger block is defined.

The present invention can also be applied to the extended macro block size proposed in the above-mentioned manner.

In the above, the H.264/AVC system is used as the encoding system/decoding system, but the present invention can also be applied to the image encoding apparatus/image decoding apparatus using the encoding system/decoding system for performing the motion prediction/compensation processing in other block units.

Also, for example, as in MPEG, H.26x, or the like, the present invention can be applied to the image encoding apparatus and the image decoding apparatus which area used at the time of receiving the image information (bit stream) compressed through the orthogonal transform such as discrete cosine transform and the motion compensation via satellite broadcasting, cable TV (television), the internet, and network media such as a mobile phone device or at the time of processing on an optical or magnetic disc, and a storage medium such as a flash memory.

The above-mentioned series of processings can be executed by hardware or can also be executed by software. In a case where the series of processing is executed by the software, a program constituting the software is installed from a program recording medium into a computer incorporated in dedicated-use hardware or, for example, a general-use personal computer or the like capable of executing various functions by installing various programs.

The program recording medium storing the program which is installed into the computer and put into an executable state by the computer is composed of a magnetic disc (including a flexible disc), an optical disc (including a CD-ROM (including Compact Disc-Read Only Memory), a DVD (Digital Versatile Disc)), and an opto-magnetic disc), or a removable medium which is a package medium composed of a semiconductor memory or the like, or a ROM, a hard disk drive, or the like temporarily or enduringly storing the program. Storage of the program into the program recording medium is carried out by utilizing a wired or wireless communication medium such as a local area network, the internet, or digital satellite broadcasting via a router or an interface such as a modem when requested.

It should be noted that in the present specification, steps that describes the program of course include a processing performed in a time-series manner while following the described order and also include a processing executed in parallel or individually although not necessarily processed in a time-series manner.

Also, embodiments of the present invention are not limited to the above-mentioned embodiments, and various changes can be made in a range without departing from the gist of the present invention.

For example, the above-mentioned image encoding apparatus 51 or the image decoding apparatus 101 can be applied to an arbitrary electronic device. Examples thereof will be described below.

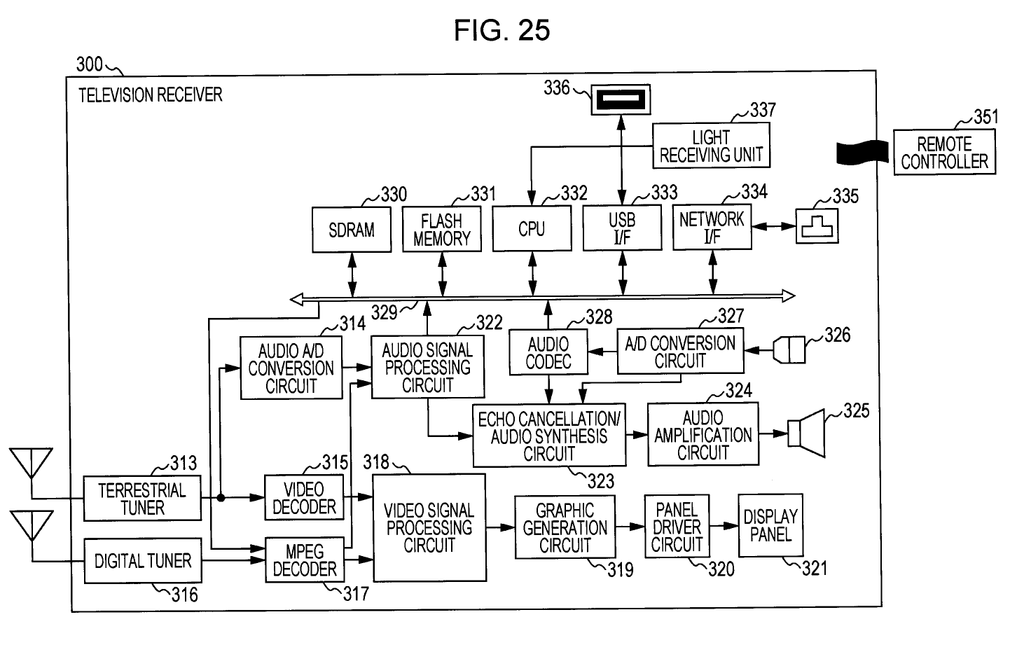

FIG. 25 is a block diagram illustrating a principal configuration example of a television receiver using the image decoding apparatus to which the present invention is applied.

A television receiver 300 illustrated in FIG. 25 has a terrestrial tuner 313, a video decoder 315, a video signal processing circuit 318, a graphic generation circuit 319, a panel driver circuit 320, and a display panel 321.

The terrestrial tuner 313 receives a broadcast wave signal of terrestrial analog broadcasting via an antenna, demodulates to obtain a video signal, and supplies it to the video decoder 315. The video decoder 315 applies a decode processing on the video signal supplied from the terrestrial tuner 313 and supplies the obtained digital component signal to the video signal processing circuit 318.

The video signal processing circuit 318 applies a predetermined processing such as noise removal with respect to the video data supplied from the video decoder 315 and supplies the obtained data to the graphic generation circuit 319.

The graphic generation circuit 319 generates video data on a program displayed by the display panel 321, image data by a processing based on an application supplied via the network, or the like and supplies the generated video data or the image data to the panel driver circuit 320. Also, the graphic generation circuit 319 appropriately performs a processing of generating video data (graphic) for displaying a screen utilized by a user for a selection of an item or the like and supplying the video data obtained by overlapping it on the video data on the program or the like to the panel driver circuit 320.

On the basis of the data supplied from the graphic generation circuit 319, the panel driver circuit 320 drives the display panel 321 and displays the video of the program and the above-mentioned various screens on the display panel 321.

The display panel 321 is composed of an LCD (Liquid Crystal Display) or the like and displays the video of the program or the like while following a control by the panel driver circuit 320.

Also, the television receiver 300 has also an audio A/D (Analog/Digital) conversion circuit 314, an audio signal processing circuit 322, an echo cancellation/audio synthesis circuit 323, an audio amplification circuit 324, and a speaker 325.

By demodulating the received broadcast wave signal, the terrestrial tuner 313 obtains not only the video signal but also an audio signal. The terrestrial tuner 313 supplies the obtained audio signal to an audio A/D conversion circuit 314.

The audio A/D conversion circuit 314 applies the A/D conversion processing on the audio signal supplied from the terrestrial tuner 313 and supplies the obtained digital audio signal to the audio signal processing circuit 322.

The audio signal processing circuit 322 applies a predetermined processing such as noise removal on the audio data supplied from the audio A/D conversion circuit 314 and supplies the obtained audio data to the echo cancellation/audio synthesis circuit 323.

The echo cancellation/audio synthesis circuit 323 supplies the audio data supplied from the audio signal processing circuit 322 to the audio amplification circuit 324.

The audio amplification circuit 324 applies the D/A conversion processing and an amplification processing with respect to the audio data supplied from the echo cancellation/audio synthesis circuit 323 and outputs the audio from the speaker 325 after being adjusted to a predetermined sound volume.

Furthermore, the television receiver 300 also has a digital tuner 316 and an MPEG decoder 317.

The digital tuner 316 receives the broadcast wave signal of digital broadcasting (terrestrial digital broadcasting, BS (Broadcasting Satellite)/CS (Communications Satellite) digital broadcasting) via the antenna, demodulates to obtain MPEG-TS (Moving Picture Experts Group-Transport Stream), and supplies it to the MPEG decoder 317.

The MPEG decoder 317 cancels a scramble applied on MPEG-TS that is supplied from the digital tuner 316 and extracts a stream including the data of the program that is a reproduction target (viewing target). The MPEG decoder 317 decodes packets constituting the extracted stream and supplies the obtained audio data to the audio signal processing circuit 322, and also decodes video packets constituting the stream and supplies the obtained video data to the video signal processing circuit 318. Also, the MPEG decoder 317 supplies EPG (Electronic Program Guide) data extracted from MPEG-TS to the CPU 332 via a path that is not illustrated in the drawing.

The television receiver 300 uses the above-mentioned image decoding apparatus 101 as the MPEG decoder 317 that decodes the video packets in this manner. Therefore, similarly as in the case of the image decoding apparatus 101, the MPEG decoder 317 generates a predicted image through the Weighted Prediction. According to this, in the same texture area within the screen, due to the factor such as gradation, in a case where the luminance has a change, the prediction error caused by the change is decreased, and as compared with the intra template matching system, it is possible to improve the encoding efficiency.

Similarly as in the case of the video data supplied from the video decoder 315, the video data supplied from the MPEG decoder 317 is subjected to a predetermined processing in the video signal processing circuit 318. Then, the video data subjected to the predetermined processing is appropriately overlapped with the generated video data or the like in the graphic generation circuit 319 and supplied via the panel driver circuit 320 to the display panel 321, and the image is displayed.

The audio data supplied from the MPEG decoder 317 is subjected to a predetermined processing in the audio signal processing circuit 322 similarly as in the case of the audio data supplied from the audio A/D conversion circuit 314. Then, the audio data subjected to the predetermined processing is supplied via the echo cancellation/audio synthesis circuit 323 to the audio amplification circuit 324 and subjected to the D/A conversion processing or the amplification processing. As a result, the audio adjusted to a predetermined sound volume is output from the speaker 325.

Also, the television receiver 300 also has a microphone 326 and an A/D conversion circuit 327.

The A/D conversion circuit 327 receives a signal of voice of a user taken by the microphone 326 provided for voice conversations to the television receiver 300. The A/D conversion circuit 327 applies the A/D conversion processing on the received audio signal and supplies the obtained digital audio data to the echo cancellation/audio synthesis circuit 323.

In a case where data on voice of a user of the television receiver 300 (user A) is supplied from the A/D conversion circuit 327, the echo cancellation/audio synthesis circuit 323 performs echo cancellation while the audio data of the user A is set as the target. Then, after the echo cancellation, the echo cancellation/audio synthesis circuit 323 outputs audio data obtained by synthesizing with other audio data or the like via the audio amplification circuit 324 from the speaker 325.

Furthermore, the television receiver 300 also has an audio codec 328, an internal bus 329, an SDRAM (Synchronous Dynamic Random Access Memory) 330, a flash memory 331, a CPU 332, a USB (Universal Serial Bus) I/F 333, and a network I/F 334.

The A/D conversion circuit 327 receives the signal of the voice of the user taken by the microphone 326 provided for voice conversations to the television receiver 300. The A/D conversion circuit 327 applies the A/D conversion processing on the received audio signal and supplies the obtained digital audio data to the audio codec 328.

The audio codec 328 converts the audio data supplied from the A/D conversion circuit 327 into data in a predetermined format for transmission via the network to be supplied via the internal bus 329 to the network I/F 334.

The network I/F 334 is connected to the network via a cable mounted to a network terminal 335. The network I/F 334 transmits, for example, the audio data supplied from the audio codec 328 to another apparatus connected to the network. Also, the network I/F 334 receives, via the network terminal 335, for example, the audio data transmitted from the other apparatus connected via the network and supplies it via the internal bus 329 to the audio codec 328.

The audio codec 328 converts the audio data supplied from the network I/F 334 into data in a predetermined format and supplies it to the echo cancellation/audio synthesis circuit 323.

The echo cancellation/audio synthesis circuit 323 performs echo cancelling while targeting the audio data supplied from the audio codec 328 and outputs the data on the voice obtained by synthesizing with other audio data or the like from the speaker 325 via the audio amplification circuit 324.

The SDRAM 330 stores various pieces of data necessary for the CPU 332 to perform the processing.

The flash memory 331 stores a program executed by the CPU 332. The program stored in the flash memory 331 is read out by the CPU 332 at a predetermined timing such as a time of activation of the television receiver 300. In the flash memory 331, EPG data obtained via the digital broadcasting, data obtained from a predetermined server via the network are also stored.

For example, in the flash memory 331, MPEG-TS including content data obtained via the network from the predetermined server by the control of the CPU 332 is stored. The flash memory 331 supplies, for example, by the control of the CPU 332, the MPEG-TS via the internal bus 329 to the MPEG decoder 317.

Similarly as in the case of the MPEG-TS supplied from the digital tuner 316, the MPEG decoder 317 processes the MPEG-TS. In this manner, the television receiver 300 can receive the content data composed of the video, the audio, and the like via the network, decode by using the MPEG decoder 317, display the video, and output the sound.

Also, the television receiver 300 also has a light receiving unit 337 that receives an infrared signal transmitted from a remote controller 351.

The light receiving unit 337 receives infrared rays from the remote controller 351 and outputs a control code representing a content of the user operation obtained through the demodulation to the CPU 332.

The CPU 332 executes the program stored in the flash memory 331 and controls the operation of the entirety of the television receiver 300 in accordance with the control code supplied from the light receiving unit 337. The CPU 332 is connected to the respective units of the television receiver 300 via a path which is not illustrated in the drawing.

A USB I/F 333 performs transmission and reception of data with an external device of the television receiver 300 which is connected via a USB cable mounted to a USB terminal 336. The network I/F 334 connects to the network via the cable mounted to the network terminal 335 and also performs transmission and reception of data other than the audio data with various apparatuses connected to the network.

By using the image decoding apparatus 101 as the MPEG decoder 317, the television receiver 300 can improve the encoding efficiency. As a result, the television receiver 300 can obtain and display the decoded image at a still higher accuracy from the broadcast wave signal received via the antenna or the content data obtained via the network.

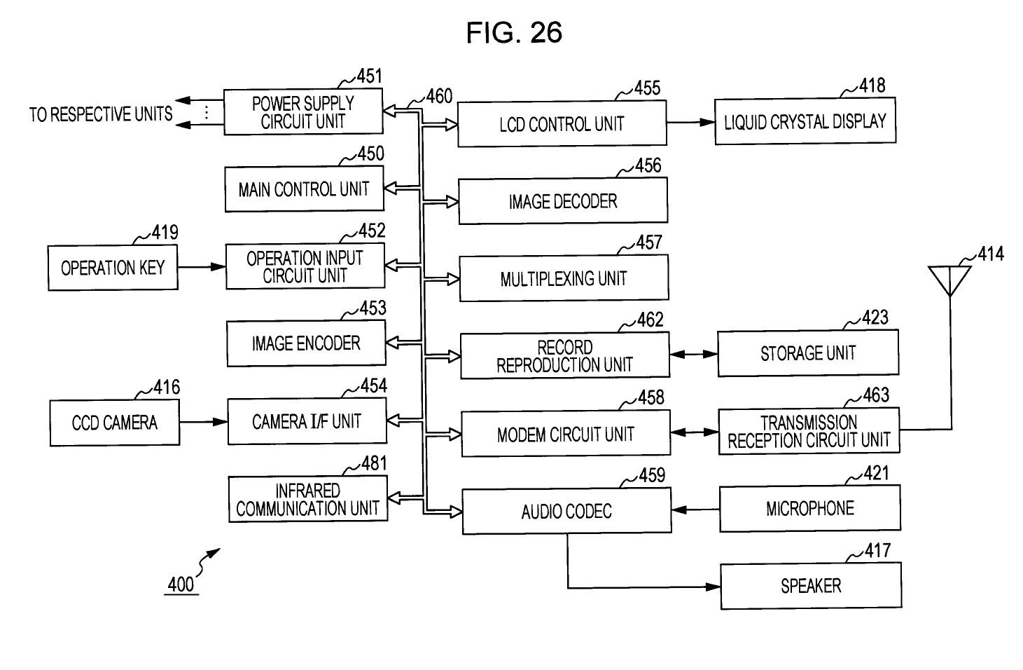

FIG. 26 is a block diagram illustrating a principal configuration example of a mobile phone device using the image encoding apparatus and the image decoding apparatus to which the present invention is applied.

A mobile telephone device 400 illustrated in FIG. 26 has a main control unit 450 arranged to control the respective units in an overall manner, a power supply circuit unit 451, an operation input circuit unit 452, an image encoder 453, a camera I/F unit 454, an LCD control unit 455, an image decoder 456, a multiplexing unit 457, a record reproduction unit 462, a modem circuit unit 458, and an audio codec 459. These are mutually connected via a bus 460.

Also, the mobile telephone device 400 also has an operation key 419, a CCD (Charge Coupled Devices) camera 416, a liquid crystal display 418, a storage unit 423, a transmission reception circuit unit 463, an antenna 414, a microphone (MIC) 421, and a speaker 417.

When a call termination and power supply key is set in an ON state by the operation of the user, by supplying power to the respective units from a battery pack, the power supply circuit unit 451 activates the mobile telephone device 400 in an operable state.

On the basis of a control of the main control unit 450 composed of the CPU, the ROM, the RAM, and the like, in various modes such as a voice conversation mode and a data communication mode, the mobile telephone device 400 performs various operations such as transmission and reception of the audio signal, transmission and reception of an electronic mail and image data, image pickup, or data recording.

For example, in the voice conversation mode, the mobile telephone device 400 converts audio signals collected by the microphone (MIC) 421 into digital audio data by the audio codec 459, performs a spread spectrum processing on this by the modem circuit unit 458 and performs a digital analog conversion processing and a frequency conversion processing by the transmission reception circuit unit 463. The mobile telephone device 400 transmits a transmission signal obtained through the conversion processings to a base station which is not illustrated in the drawing via the antenna 414. The transmission signal transmitted to the base station (audio signal) is supplied to a mobile phone device of the conversation other party via a public telephone circuit network.

Also, for example, in the voice conversation mode, the mobile telephone device 400 amplifies the reception signal received by the antenna 414 by the transmission reception circuit unit 463, and further performs the frequency conversion processing and an analog digital conversion processing, performs a spectrum inverse diffusion processing by the modem circuit unit 458, and converts into an analog audio signal by the audio codec 459. The mobile telephone device 400 outputs the analog audio signal obtained through the conversions from the speaker 417.

Furthermore, for example, in a case where an electric mail is transmitted in the data communication mode, the mobile telephone device 400 accepts text data of the electric mail input through the operation of the operation key 419 by the operation input circuit unit 452. The mobile telephone device 400 processes the text data in the main control unit 450 to be displayed via the LCD control unit 455 as an image on the liquid crystal display 418.

Also, in the main control unit 450, the mobile telephone device 400 generates electric mail data on the basis of the text data accepted by the operation input circuit unit 452, a user instruction, or the like. The mobile telephone device 400 performs the spread spectrum processing on the electric mail data by the modem circuit unit 458 and performs the digital analog conversion processing and the frequency conversion processing by the transmission reception circuit unit 463. The mobile telephone device 400 transmits a transmission signal obtained through the conversion processings to the base station which is not illustrated in the drawing via the antenna 414. The transmission signal transmitted to the base station (electric mail) is supplied to a predetermined address via a network, a mail server, or the like.

Also, for example, in a case where the electric mail is received in the data communication mode, the mobile telephone device 400 receives the signal transmitted from the base station via the antenna 414 by the transmission reception circuit unit 463, amplifies, and further performs the frequency conversion processing and the analog digital conversion processing. The mobile telephone device 400 performs the spectrum inverse diffusion processing on the reception signal by the modem circuit unit 458 to restore the original electric mail data. The mobile telephone device 400 displays the restored electric mail data via the LCD control unit 455 on the liquid crystal display 418.

It should be noted that the mobile telephone device 400 can also record (store) the received electronic mail data via the record reproduction unit 462 in the storage unit 423.

This storage unit 423 is a rewritable arbitrary storage medium. The storage unit 423 may be, for example, a RAM or a semiconductor memory such as a built-in type flash memory or may be a hard disc, or may be a magnetic disc, an optomagnetic disc, an optical disc, a USB memory, or a removable medium such as a memory card. Of course, it may also be other then these.

Furthermore, for example, in a case where the image data is transmitted in the data communication mode, the mobile telephone device 400 generates image data through image pickup by the CCD camera 416. The CCD camera 416 has optical devices such as a lens and an aperture and a CCD as a photoelectric conversion element, picks up an image of a subject, converts an intensity of received light into an electric signal, and generates image data on the image of the subject. The image data is converted into encoding image data by compressing and encoding via the camera I/F unit 454 by the image encoder 453, for example, through a predetermined encoding system such as MPEG2 or MPEG4.

The mobile telephone device 400 uses the above-mentioned image encoding apparatus 51 as the image encoder 453 that performs such a processing. Therefore, similarly as in the case of the image encoding apparatus 51, the image encoder 453 generates a predicted image through the Weighted Prediction. According to this, in the same texture area within the screen, due to the factor such as gradation, in a case where the luminance has a change, the prediction error caused by the change is decreased, and as compared with the intra template matching system, it is possible to improve the encoding efficiency.

It should be noted that at this time, simultaneously, the mobile telephone device 400 performs analog digital conversion in the audio codec 459 on the sound collected by the microphone (MIC) 421 in the CCD camera 416 during the image pickup and further performs encoding.

In the multiplexing unit 457, the mobile telephone device 400 multiplexes the encoding image data supplied from the image encoder 453 with the digital audio data supplied from the audio codec 459 in a predetermined system. The mobile telephone device 400 performs the spread spectrum processing on the multiplexed data obtained as the result by the modem circuit unit 458 and performs the digital analog conversion processing and the frequency conversion processing by the transmission reception circuit unit 463.

The mobile telephone device 400 transmits a transmission signal obtained through the conversion processings to the base station which is not illustrated in the drawing via the antenna 414. The transmission signal transmitted to the base station (image data) is supplied via the network or the like to the communication other party.

It should be noted that in a case where the image data is not transmitted, the mobile telephone device 400 can also display the image data generated by the CCD camera 416 on the liquid crystal display 418 via the LCD control unit 455 instead of the image encoder 453.

Also, for example, in the data communication mode, in a case where data on a moving image file which is linked to a simplified home page or the like is received, the mobile telephone device 400 receives the signal transmitted from the base station via the antenna 414 by the transmission reception circuit unit 463, amplifies, and further performs the frequency conversion processing and the analog digital conversion processing. The mobile telephone device 400 performs the spectrum inverse diffusion processing by the modem circuit unit 458 on the reception signal to restore the original multiplexed data. In the multiplexing unit 457, the mobile telephone device 400 separates the multiplexed data into the encoding image data and the audio data.

In the image decoder 456, the mobile telephone device 400 generates reproduction moving image data by decoding the encoding image data in a decoding system corresponding to a predetermined encoding system such as MPEG2 or MPEG4 and displays this via the LCD control unit 455 on the liquid crystal display 418. According to this, for example, video data included in the moving image file which is linked to the simplified home page is displayed on the liquid crystal display 418.

The mobile telephone device 400 uses the above-mentioned image decoding apparatus 101 as the image decoder 456 that performs such a processing. Therefore, the image decoder 456 generates a predicted image through the Weighted Prediction similarly as in the case of the image decoding apparatus 101. According to this, in the same texture area within the screen, due to the factor such as gradation, in a case where the luminance has a change, the prediction error caused by the change is decreased, and as compared with the intra template matching system, it is possible to improve the encoding efficiency.

At this time, simultaneously, in the audio codec 459, the mobile telephone device 400 converts the digital audio data into the analog audio signal and outputs this from the speaker 417. According to this, for example, the audio data included in the moving image file which is linked to the simplified home page is reproduced.

It should be noted that similarly as in the case of the electronic mail, the mobile telephone device 400 can also record (store) the received data which is linked to the simplified home page or the like via the record reproduction unit 462 in the storage unit 423.

Also, in the main control unit 450, the mobile telephone device 400 can analyze a two-dimensional code picked up and obtained by the CCD camera 416 and obtain information recorded on the two-dimensional code.

Furthermore, the mobile telephone device 400 can communicate with an external device by way of infrared rays by an infrared communication unit 481.

By using the image encoding apparatus 51 as the image encoder 453, for example, the mobile telephone device 400 can encode the image data generated in the CCD camera 416 and improve the encoding efficiency of the generated encoded data. As a result, the mobile telephone device 400 can provide the encoded data with a satisfactory encoding efficiency (image data) to another apparatus.

Also, by using the image decoding apparatus 101 as the image decoder 456, the mobile telephone device 400 can generate the predicted image at the high accuracy. As a result, for example, from the moving image file which is linked to the simplified home page, the mobile telephone device 400 can obtain and display the decoded image with the still higher resolution.

It should be noted that in the above, the description has been given in which the mobile telephone device 400 uses the CCD camera 416, but instead of this CCD camera 416, an image sensor using CMOS (Complementary Metal Oxide Semiconductor) (CMOS image sensor) may also be used. In this case too, similarly as in the case of using the CCD camera 416, the mobile telephone device 400 can pick up the image of the subject and generate the image data on the image of the subject.

Also, in the above, the description has been given as the mobile telephone device 400, but similarly as in the case of the mobile telephone device 400, the image encoding apparatus 51 and the image decoding apparatus 101 can be applied to any apparatus as long as the apparatus has an image pickup function and a communication function similar to this mobile telephone device 400, for example, a PDA (Personal Digital Assistants), a smart phone, a UMPC (Ultra Mobile Personal Computer), a net book, a laptop personal computer, or the like.

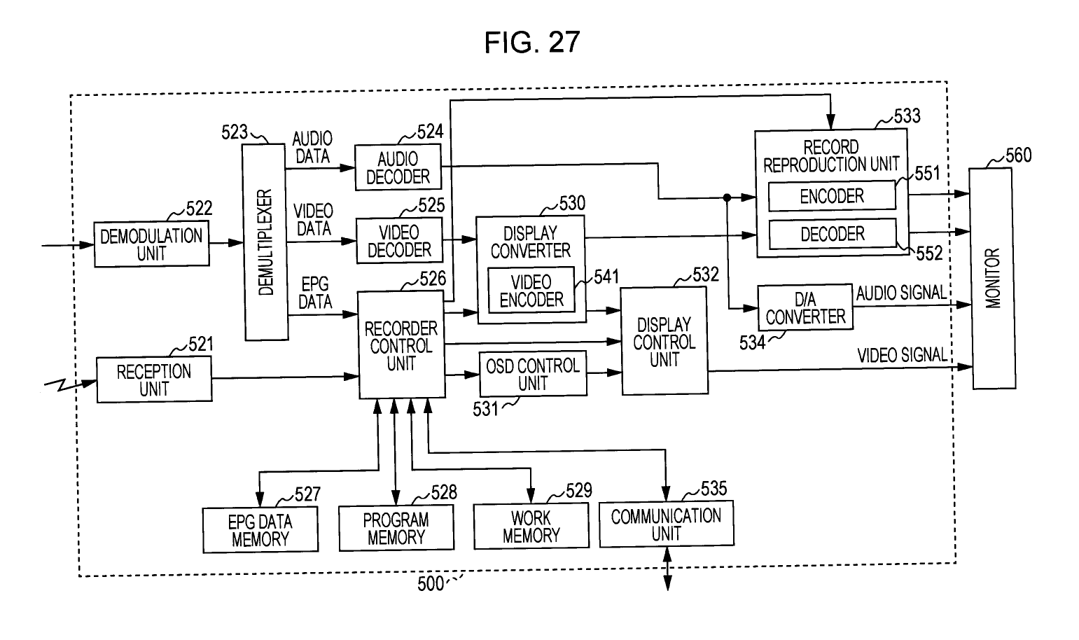

FIG. 27 is a block diagram illustrating a principal configuration example of a hard disc recorder using the image encoding apparatus and the image decoding apparatus to which the present invention is applied.

A hard disc recorder (HDD recorder) 500 illustrated in FIG. 27 is an apparatus that saves audio data and video data on a broadcasting program included in a broadcast wave signal (television signal) transmitted by a satellite or terrestrial antenna or the like which is received by a tuner in a built-in hard disc and provides the saved data to a user at a timing in accordance with an instruction of the user.

The hard disc recorder 500 can extract the audio data and the video data, for example, from the broadcast wave signal and appropriately decode those to be stored in the built-in hard disc. Also, the hard disc recorder 500 can obtain the audio data and the video data, for example, from another apparatus via the network and appropriately decode those to be stored in the built-in hard disc.

Furthermore, the hard disc recorder 500 decodes, for example, the audio data and the video data in the built-in hard disc to be supplied to a monitor 560 and displays the image on a screen of the monitor 560. Also, the hard disc recorder 500 can output the sound from a speaker of the monitor 560.

The hard disc recorder 500 decodes, for example, the audio data and the video data extracted from the broadcast wave signal which is obtained via the tuner or the audio data and the video data obtained from another apparatus via the network to be supplied to the monitor 560 and displays the image on the screen of the monitor 560. Also, the hard disc recorder 500 can output the sound from the speaker of the monitor 560.

Of course, operations other than this can also be available.

As illustrated in FIG. 27, the hard disc recorder 500 has a reception unit 521, a demodulation unit 522, a demultiplexer 523, an audio decoder 524, a video decoder 525, and a recorder control unit 526. The hard disc recorder 500 further has an EPG data memory 527, a program memory 528, a work memory 529, a display converter 530, an OSD (On Screen Display) control unit 531, a display control unit 532, a record reproduction unit 533, a D/A converter 534, and a communication unit 535.

Also, the display converter 530 has a video encoder 541. The record reproduction unit 533 has an encoder 551 and a decoder 552.

The reception unit 521 receives an infrared signal from a remote controller (not illustrated in the drawing) to be converted into an electric signal and output to the recorder control unit 526. The recorder control unit 526 is composed, for example, of a micro processor or the like and executes various processings while following programs stored in the program memory 528. At this time, the recorder control unit 526 uses the work memory 529 when requested.

The communication unit 535 is connected to the network and performs a communication processing with another apparatus via the network. For example, the communication unit 535 is controlled by the recorder control unit 526, communicates with the tuner (not illustrated in the drawing), and mainly outputs a channel select control signal to the tuner.

The demodulation unit 522 demodulates the signal supplied from the tuner to be output to the demultiplexer 523. The demultiplexer 523 separates the data supplied from the demodulation unit 522 into the audio data, the video data, and the EPG data to be respectively output to the audio decoder 524, the video decoder 525, or the recorder control unit 526.

The audio decoder 524 decodes the input audio data, for example, in the MPEG system to be output to the record reproduction unit 533. The video decoder 525 decodes the input video data, for example, in the MPEG system to be output to the display converter 530. The recorder control unit 526 supplies the input EPG data to the EPG data memory 527 to be stored.

The display converter 530 encodes the video data supplied from the video decoder 525 or the recorder control unit 526 by the video encoder 541, for example, into video data of NTSC (National Television Standards Committee) system to be output to the record reproduction unit 533. Also, the display converter 530 converts a size of a screen of the video data supplied from the video decoder 525 or the recorder control unit 526 into a size corresponding to a size of the monitor 560. The display converter 530 further converts the video data where the size of the screen is converted into video data of NTSC system by the video encoder 541 to be converted into an analog signal and output to the display control unit 532.

Under a control of the recorder control unit 526, the display control unit 532 overlaps an OSD signal output by the OSD (On Screen Display) control unit 531 with the video signal input by the display converter 530 to be output to the display of the monitor 560 and displayed.

The monitor 560 is also supplied with the audio data that is output by the audio decoder 524 and converted into the analog signal by the D/A converter 534. The monitor 560 outputs this audio signal from the built-in speaker.

The record reproduction unit 533 has a hard disc as a storage medium that records the video data, the audio data, and the like.

The record reproduction unit 533 encodes, for example, the audio data supplied from the audio decoder 524 in the MPEG system by the encoder 551. Also, the record reproduction unit 533 encodes the video data supplied from the video encoder 541 of the display converter 530 by the encoder 551 in the MPEG system. The record reproduction unit 533 synthesizes the encoded data of the audio data and the encoded data of the video data by a multiplexer. The record reproduction unit 533 performs channel coding on the synthesized data to amplify and write the data into the hard disc via a recording head.

The record reproduction unit 533 reproduces the data recorded in the hard disc via a reproduction head to be amplified and separated into audio data and video data by a demultiplexer. The record reproduction unit 533 decodes the audio data and the video data by the decoder 552 in the MPEG system. The record reproduction unit 533 performs D/A conversion on the decoded audio data to be output to the speaker of the monitor 560. Also, the record reproduction unit 533 performs D/A conversion on the decoded video data to be output to the display of the monitor 560.

The recorder control unit 526 reads out the latest EPG data from the EPG data memory 527 on the basis of the user instruction indicated by the infrared signal received via the reception unit 521 from the remote controller and supplies it to the OSD control unit 531. The OSD control unit 531 generates image data corresponding to the input EPG data to be output to the display control unit 532. The display control unit 532 outputs the video data input from the OSD control unit 531 to the display of the monitor 560 to be displayed. According to this, the EPG (electronic program guide) is displayed on the display of the monitor 560.

Also, the hard disc recorder 500 can obtain various pieces of data such as the video data, the audio data, or the EPG data supplied from another apparatus via the network such as the internet.

The communication unit 535 is controlled by the recorder control unit 526, obtains encoded data such as the video data, the audio data, or the EPG data transmitted from another apparatus via the network and supplies it to the recorder control unit 526. The recorder control unit 526 supplies, for example, the obtained encoded data such as the video data or the audio data to the record reproduction unit 533 to be stored in the hard disc. At this time, the recorder control unit 526 and the record reproduction unit 533 may also perform a processing such as re-encoding when requested.

Also, the recorder control unit 526 decodes the encoded data such as the obtained video data or the audio data and supplies the video data to be obtained to the display converter 530. The display converter 530 processes the video data supplied from the recorder control unit 526 similarly as in the video data supplied from the video decoder 525 to be supplied via the display control unit 532 to the monitor 560 and displays the image.

Also, in accordance with this image display, the recorder control unit 526 may supply the decoded audio data via the D/A converter 534 to the monitor 560 and output the sound from the speaker.

Furthermore, the recorder control unit 526 decodes the encoded data of the obtained EPG data and supplies the decoded EPG data to the EPG data memory 527.

The hard disc recorder 500 mentioned above uses the image decoding apparatus 101 as a decoder built in the video decoder 525, the decoder 552, and the recorder control unit 526. Therefore, the video decoder 525, the decoder 552, and the decoder built in the recorder control unit 526 generate a predicted image through the Weighted Prediction similarly as in the case of the image decoding apparatus 101. According to this, in the same texture area within the screen, due to the factor such as gradation, in a case where the luminance has a change, the prediction error caused by the change is decreased, and as compared with the intra template matching system, it is possible to improve the encoding efficiency.

Therefore, the hard disc recorder 500 can generate the predicted image at the high accuracy. As a result, the hard disc recorder 500 can obtain the decoded image with the still higher resolution, for example, from the encoded data of the video data received via the tuner, the encoded data of the video data read out from the hard disc of the record reproduction unit 533, and the encoded data of the video data obtained via the network to be displayed on the monitor 560.

Also, the hard disc recorder 500 uses the image encoding apparatus 51 as the encoder 551. Therefore, the encoder 551 generates a predicted image through the Weighted Prediction similarly as in the case of the image encoding apparatus 51. According to this, in the same texture area within the screen, due to the factor such as gradation, in a case where the luminance has a change, the prediction error caused by the change is decreased, and as compared with the intra template matching system, it is possible to improve the encoding efficiency.

Therefore, the hard disc recorder 500 can improve the encoding efficiency of the encoded data recorded, for example, on the hard disc. As a result, the hard disc recorder 500 can use a storage area of the hard disc more efficiently.

It should be noted that in the above, the hard disc recorder 500 that records the video data and the audio data in the hard disc has been described, but of course, any recoding medium may suffice. For example, the image encoding apparatus 51 and the image decoding apparatus 101 can be applied even to a recorder to which a recoding medium other than the hard disc such as a flash memory, an optical disc, or a video tape is applied similarly as in the case of the above-mentioned hard disc recorder 500.

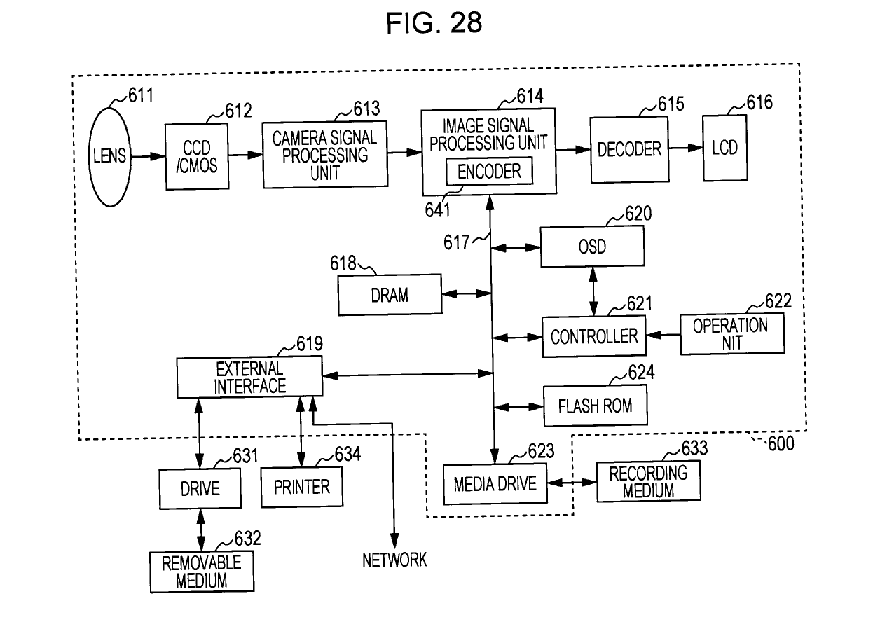

FIG. 28 is a block diagram illustrating a principal configuration example of a camera using the image decoding apparatus and the image encoding apparatus to which the present invention is applied.

A camera 600 illustrated in FIG. 28 picks up an image of a subject and displays the image of the subject on an LCD 616 or records it in a recording medium 633 as image data.

A lens block 611 causes light (that is, video of the subject) to be incident to the CCD/CMOS 612. A CCD/CMOS 612 is an image sensor using a CCD or a CMOS and converts an intensity of the received light into an electric signal to be supplied to a camera signal processing unit 613.

The camera signal processing unit 613 converts the electric signal supplied from the CCD/CMOS 612 into color difference signals Y, Cr, and Cb to be supplied to an image signal processing unit 614. Under a control of a controller 621, the image signal processing unit 614 performs a predetermined image processing on the image signal supplied from the camera signal processing unit 613 and encodes the image signal by an encoder 641, for example, in the MPEG system. The image signal processing unit 614 supplies the encoded data generated by encoding the image signal to a decoder 615. Furthermore, the image signal processing unit 614 obtains the display data generated in an on screen display (OSD) 620 and supplies it to the decoder 615.

In the above processing, the camera signal processing unit 613 appropriately utilizes a DRAM (Dynamic Random Access Memory) 618 connected via a bus 617 and holds image data, encoded data obtained by encoding the image data, or the like in the DRAM 618 when requested.

The decoder 615 decodes the encoded data supplied from the image signal processing unit 614 and supplies the obtained image data (decoded image data) to the LCD 616. Also, the decoder 615 supplies the display data supplied from the image signal processing unit 614 to the LCD 616. The LCD 616 appropriately synthesizes the image of the decoded image data supplied from the decoder 615 with the image of the display data and displays the synthesized image.

Under the control of the controller 621, the on screen display 620 outputs a menu screen composed of symbols, characters, or figures or display data such as icons via the bus 617 to the image signal processing unit 614.

On the basis of signals indicating contents instructed by the user by using an operation unit 622, the controller 621 executes various processings and also controls the image signal processing unit 614, the DRAM 618, an external interface 619, the on screen display 620, a media drive 623, and the like via the bus 617. A flash ROM 624 stores programs, data, and the like necessary for the controller 621 to execute various processings.

For example, the controller 621 can encode image data stored in the DRAM 618 instead of the image signal processing unit 614 or the decoder 615 or decode the encoded data stored in the DRAM 618. At this time, the controller 621 may perform the encoding/decoding processing in a system to similar the encoding/decoding system of the image signal processing unit 614 or the decoder 615 or may also perform the encoding/decoding processing in a system to which the image signal processing unit 614 or the decoder 615 does not correspond.

Also, for example, in a case where start of the image print is instructed from the operation unit 622, the controller 621 reads out the image data from the DRAM 618 and supplies it to a printer 634 connected via the bus 617 to the external interface 619 to be printed.

Furthermore, for example, in a case where image record is instructed from the operation unit 622, the controller 621 reads out the encoded data from the DRAM 618 to be supplied to the recording medium 633 mounted to the media drive 623 via the bus 617.

The recording medium 633 is, for example, an arbitrary readable writable removable medium such as a magnetic disc, an opto-magnetic disc, an optical disc, or a semiconductor memory. A type of the recording medium 633 as the removable medium is, of course, arbitrary and may be a tape device, may be a disc, or may be a memory card. Of course, it may be a non-contact IC card or the like.

Also, it may be composed of a non-transportable storage medium by integrating the media drive 623 with the recording medium 633 such as, for example, the built-in type hard disc drive or the SSD (Solid State Drive).

The external interface 619 is composed, for example, of a USB input and output terminal and connected to the printer 634 in a case where the image printing is performed. Also, a drive 631 is connected to the external interface 619 when requested, a removable medium 632 such as the magnetic disc, the optical disc, or the opto-magnetic disc is appropriately mounted, and a computer program read out from those is installed into the flash ROM 624 when requested.

Furthermore, the external interface 619 has a network interface connected to a predetermined network such as LAN or the internet. For example, while following an instruction from the operation unit 622, the controller 621 can read out the encoded data from the DRAM 618 and supplies it from the external interface 619 to an another apparatus connected via the network. Also, the controller 621 can obtain the encoded data or the image data supplied from another apparatus via the network via the external interface 619 to cause the DRAM 618 to hold it or supply to the image signal processing unit 614.

The above-mentioned camera 600 uses the image decoding apparatus 101 as the decoder 615. Therefore, the decoder 615 generates a predicted image through the Weighted Prediction similarly as in the case of the image decoding apparatus 101. According to this, in the same texture area within the screen, due to the factor such as gradation, in a case where the luminance has a change, the prediction error caused by the change is decreased, and as compared with the intra template matching system, it is possible to improve the encoding efficiency.

Therefore, the camera 600 can generate the predicted image at the high accuracy. As a result, the camera 600 can obtain the decoded image with the still higher resolution, for example, the image data from generated in the CCD/CMOS 612, the encoded data of the video data read out from the DRAM 618 or the recording medium 633, or the encoded data of the video data obtained via the network and can display on the LCD 616.

Also, the camera 600 uses the image encoding apparatus 51 as the encoder 641. Therefore, similarly as in the case of the image encoding apparatus 51, the encoder 641 generates a predicted image through the Weighted Prediction. According to this, in the same texture area within the screen, due to the factor such as gradation, in a case where the luminance has a change, the prediction error caused by the change is decreased, and as compared with the intra template matching system, it is possible to improve the encoding efficiency.

Therefore, the camera 600 can improve the encoding efficiency of the encoded data to be recorded, for example, on the hard disc. As a result, the camera 600 can use the storage area of the DRAM 618 and the recording medium 633 more efficiently.

It should be noted that the decoding method of the image decoding apparatus 101 may be applied to the decoding processing carried out by the controller 621. Similarly, the encoding method of the image encoding apparatus 51 may be applied to the encoding processing performed by the controller 621.

Also, the image data picked up by the camera 600 may be a moving image or may be a still image.

Of course, the image encoding apparatus 51 and the image decoding apparatus 101 can also be applied to apparatus and systems other than the above-mentioned apparatuses.

### REFERENCE SIGNS LIST

51 image encoding apparatus

66 lossless encoding unit

75 intra template matching unit

76 weighting factor calculation unit

101 image decoding apparatus

122 intra template matching unit

123 weighting factor calculation unit

1. An image processing apparatus comprising:
matching means that performs a matching processing based on an intra template matching system for a block of an image in a frame of an encoding processing or decoding target; and
prediction means that performs a weighted prediction by the matching means with respect to the matching processing.

2. The processing apparatus according to claim 1,
wherein the prediction means performs the weighted prediction on the basis of flag information representing whether the weighted prediction is performed when the image is encoded.

3. The processing apparatus according to claim 2,
wherein the flag information indicates the weighted prediction is performed in a picture unit, a macro block unit, or a block unit, and
wherein the prediction means refers to the flag information to perform the weighted prediction in the picture unit, the macro block unit, or the block unit.

4. The processing apparatus according to claim 3,
wherein the flag information indicates that the weighted prediction is performed in the macro block unit, and in a case where the flag information of the macro block is different from flag information of an adjacent macro block, the flag information is inserted to information including the image in the frame of the decoding target.

5. The processing apparatus according to claim 3,
wherein the flag information indicates that the weighted prediction is performed in the block unit, and in a case where the flag information of the block is different from flag information of an adjacent block, the flag information is inserted to information including the image in the frame of the decoding target.

6. The processing apparatus according to claim 1,
wherein the prediction means performs the weighted prediction by using a weighting factor.

7. The processing apparatus according to claim 6,
wherein the prediction means performs the weighted prediction by using the weighting factor inserted to information including the image in the frame of the decoding target.

8. The processing apparatus according to claim 6, further comprising:
calculation means that calculates the weighting factor by using pixel values of templates in the intra template matching system and pixel values of matching areas that are areas in a search range where a correlation with the template is highest.

9. The processing apparatus according to claim 8,
wherein the calculation means calculates the weighting factor by using an average value of the pixel values of the templates and an average value of the pixel values of the matching areas.

10. The processing apparatus according to claim 9,
wherein the calculation means calculates the weighting factor through an expression while the average value of the pixel values of the templates is set as Ave(Cur_tmplt), the average value of the pixel values of the matching areas is set as Ave(Ref_tmplt), and the weighting factor is set as w₀:
w₀=Ave(Cur_tmplt)/Ave(Ref_tmplt).

11. The processing apparatus according to claim 10,
wherein the calculation means approximates the weighting factor w₀ to a value represented in a format of X/(2ⁿ).

12. The processing apparatus according to claim 10,
wherein the prediction means calculates the predicted pixel value through an expression using the weighting factor w₀ when a predicted pixel value of the block is set as Pred(Cur) and a pixel value of an area having an identical positional relation with a positional relation between the template and the block between the matching areas is set as Ref:
Pred(Cur)=w₀×Ref.

13. The processing apparatus according to claim 12,
wherein the prediction means performs a clip processing in a manner that the predicted pixel value has a value in a range from 0 to an upper limit value that the pixel value of the image of the decoding target may take.

14. The processing apparatus according to claim 1,
wherein the prediction means performs the weighted prediction by using an offset.

15. The processing apparatus according to claim 14,
wherein the prediction means performs the weighted prediction by using the offset inserted to information including the image in the frame of the decoded target.

16. The processing apparatus according to claim 14, further comprising:
calculation means that calculates the offset by using a pixel value of a template in the intra template matching system and a pixel value of a matching area that is an area in a search range where a correlation with the template is highest.

17. The processing apparatus according to claim 16,
wherein the calculation means calculates the offset by using an average value of the pixel values of the templates and an average value of the pixel values of the matching areas.

18. The processing apparatus according to claim 17,
wherein the calculation means calculates the offset through an expression when the average value of the pixel values of the templates is set as Ave(Cur_tmplt), the average value of the pixel values of the matching areas is set as Ave(Ref_tmplt), and the offset is set as d₀:
d₀=Ave(Cur_tmplt)−Ave(Ref_tmplt).

19. The processing apparatus according to claim 18,
wherein the prediction means calculates the predicted pixel value through an expression using the offset d₀ when a predicted pixel value of the block is set as Pred(Cur) and a pixel value of an area having an identical positional relation with a positional relation between the template and the block between the matching areas is set as Ref:
Pred(Cur)=Ref+d₀.

20. The processing apparatus according to claim 19,
wherein the prediction means performs a clip processing in a manner that the predicted pixel value has a value in a range from 0 to an upper limit value that the pixel value of the image of the decoding target may take.

21. An image processing method comprising the steps of:
causing an image processing apparatus to perform a matching processing based on an intra template matching system for a block of an image in a frame of a decoding target; and
performing a weighted prediction with respect to the matching processing.
